(19) United States
(12) Patent Application Publication
(10) Pub. No.: US 2006/0190483 A1
(43) Pub. Date: Aug. 24, 2006

(54) Data registration/search support device using a keyword

(76) Inventors: Masanari Takahashi, Chiba (JP); Hiroaki Homma, Chiba (JP)

Correspondence Address: CANTOR COLBURN, LLP, 55 GRIFFIN ROAD SOUTH, BLOOMFIELD, CT, 06002, US

(21) Appl. No.: 10/548,901

(22) PCT Filed: Mar. 12, 2004
(86) PCT No.: PCT/JP04/03260

§ 371 Date: Sep. 12, 2005

(30) Foreign Application Priority Data
Dec. 3, 2003 (JP) P2003-067108

(51) Int. Cl. G06F 17/00

(52) U.S. Cl. 707/104.1

(57) ABSTRACT

A display unit (614) displays a keyword search/enter screen, a registering work screen, and the like. A search processing unit (616) accepts an entry of a keyword from a keyword search screen, and presents report information stored in a report DB (630) to a report preparing person. A registration processing unit (618) accepts the entry of the keyword from a keyword entry screen and prepares a report including, as report information, the keyword, a material prepared by the report preparing person, and report information designated by the report preparing person in the report information presented by the search processing unit (616). Keywords are displayed in a keyword search and a keyword entry by displaying a list of all of options on the same screen.

### TECHNICAL FIELD

The present invention relates to an apparatus for supporting data registration/search using a keyword and to a report preparation supporting apparatus and program.

### BACKGROUND ART

Hitherto, various reports, technical documents, and the like in a company are managed and stored by each of persons in charge or each of groups in charge. Such documents are often stored in the form of paper and the amount of the documents is enormous and it causes problems such that the cost of storage is high and it is difficult to use the documents. To solve such problems, attempts are being made to compile reports and the like into databases. Most of the attempts have, however, a common problem that storage of data does not progress so much. The causes of the problem are as follows: in addition to preparation of reports and the like, efforts have to be made to enter the reports and the like into a database, consequently, at the time such that the user is busy, the entry is delayed and, as a result, is not performed. Since an input operation is complicated, the user who is unfamiliar with operations of a computer gives a wide berth to data entry. One of the causes is that, since the usefulness of a database is displayed only after a predetermined amount of data is stored, in the stage the usefulness does not appear clearly, motivation for data entry is low. Report documents and the like include not only documents in an electronic file format of a word processor the like but also documents in the paper form. It is difficult to manage the materials of different forms uniformly in a conventional database.

At the time of constructing a database, if data to be registered is associated with a keyword so that a keyword search can be made later, it is convenient. Patent Document 1 discloses an apparatus for storing information in a database so as to be associated with a keyword and conducting an information search by a keyword search. However, it generally takes time and manpower to enter a keyword, and only data is often registered without a keyword entry.

When a database becomes large and comes to store documents in various fields, the number of keywords used for input increases, and it becomes more complicated to enter keywords. For example, a method of sequentially opening selection windows of a pull-down menu in a conventional search/registration screen, like major concept, middle concept, and minor concept and selecting a keyword from the selection windows is widely used. By such a method, a search can be conducted by various keywords. However, the method has problems such that keywords as a whole cannot be grasped, it takes some time and effort for an operation of moving to a keyword of a subordinate concept belonging to a different major concept, and operability is low.

Further, in a method of selecting a term at the disposal of a registrant even if a keyword is input, in many cases, information sufficient to be searched is not always registered. Since the same term is input as keywords which vary among data-entry persons, it causes a situation such that, for example, when a search is made with a keyword of “silicon”, documents registered with keywords of “Si” and “Keiso (in Japanese)” are not retrieved.

Non-patent document 1 describes a document preparation supporting system which registers a prepared document into a database and enables the document to be retrieved with a keyword, a document number, and the like. It is not described that a keyword is entered at the time of registering a document into a database. In the section of “4.3.1 Document structure defining function” in the right column of page 46 of the document, as the document structure defining function, creation of a new folder and a change in the attributes (including a keyword) of a designated folder are written. That is, in the system, a folder for storing a document is created and, at the same time, a keyword is automatically input. The keywords are, as described in page 48 of the document and in FIG. 10, keywords of bibliographical items such as document and person names, sections, and titles. A configuration of selecting and entering a keyword peculiar to a document by a document creator is now described.

In the invention described in the non-patent document 1, as shown in the diagram of page 44, HTML is created according to a document input, temporarily registered and, after that, probated. The description corresponding to the configuration is in the first and second lines of the section of “4.3.2 Temporary registering function” in the right column of page 46. It is described that when a creator completes creation of a document, a temporary registration notification is sent to a temporary registrant. That is, after a document is created, it is registered by a human.

Since the non-patent document 1 has such a configuration, a keyword is not certainly registered at the time of inputting a document. From the viewpoint of constructing a usable database, there is room for improvement.

Patent document 1: Japanese Patent application Laid-Open No. 10-149369

Non-patent document 1: Sakurai et al., “IS014001-compatible document management system using Intranet”, Mitsubishi Electric Technical Report, Japan, Jul. 25, 1997, Vol. 71, No. 7, p. 44 to 59

### DISCLOSURE OF THE INVENTION

As described above, the database management for a document and the like by using a keyword has important technical challenges to reduce time and manpower for keyword entry and to make an entered keyword used effectively at the time of a search. In view of the above circumstances, an object of the present invention is to provide a technique for supporting a keyword registration to a database and a keyword search.

Another object of the present invention is to provide a report preparation supporting technique for making creation of a report progress smoothly and storing data of the report into a database with reliability.

According to the present invention, there is provided a database registration supporting apparatus for supporting the user to register data into a database so as to associate the data with a keyword, including: a display unit for simultaneously displaying all of options of keywords which can be input on a data registration screen and encouraging the user to select any of the keywords; a keyword input accepting unit for accepting the selected keyword; and a registration executing unit for registering the data in the database so as to associate the data with the keyword.

According to the present invention, there is provided a database registration supporting apparatus for supporting the user to register data into a database so as to associate the data with a keyword, including: a display unit for presenting a data registration screen and simultaneously displaying all of options of keywords which can be input on the data registration screen; a keyword input accepting unit, when a displayed option is clicked, which recognizes that the option is selected as a keyword; and a registration executing unit for registering the data in the database so as to be associated with the selected keyword.

The database registration supporting apparatus according to the invention may further include a user information input unit for encouraging input of user identification information, and the display unit presents the data registration screen by referring to the identification information that is input.

The database registration supporting apparatus according to the invention may further include a keyword use history storing unit for storing a keyword use history associated with a user, and the display unit refers to the keyword use history on the basis of the identification information that is input, extracts predetermined number of keywords in the decreasing order of use frequency from the keywords used for registration by the user in the past, and emphasizes and displays the extracted keywords on the registration screen.

The database registration supporting apparatus according to the invention may further include: a keyword group database for storing a plurality of keyword groups; and a keyword group selecting unit for selecting a specific keyword group from the keyword group database on the basis of the identification information that is input, and the display unit displays the specific keyword group selected by the keyword group selecting unit as all of options of keywords which can be input.

According to the invention, there is also provided a database search supporting apparatus for supporting the user to retrieve data stored in a database by using a keyword, including: a display unit for simultaneously displaying all of options of keywords which can be input on a data search screen, encouraging the user to select any of the keywords and, when a keyword is selected, displaying a set of the selected keyword and the number of pieces of data including the keyword on the search screen; and a search executing unit for starting a search with the selected keyword in response to a search start request.

According to the invention, there is also provided a database search supporting apparatus for supporting the user to retrieve data stored in a database by using a keyword, including: a display unit for presenting a data search screen, simultaneously displaying all of options of keywords which can be input on the data registration screen, when a displayed option is clicked, recognizing that the option is selected as a keyword, and displaying a set of the selected keyword and the number of data pieces including the keyword on the search screen; and a search executing unit for starting a search with the selected keyword in response to a search start request.

The database search supporting apparatus according to the invention may further include a user information input unit for encouraging input of user identification information, and the display unit presents the data search screen by referring to the identification information that is input.

The database search supporting apparatus according to the invention may further include a keyword use history storing unit for storing a keyword use history associated with a user, and the display unit refers to the keyword use history on the basis of the identification information that is input, extracts predetermined number of keywords in the decreasing order of use frequency from the keywords used for searches by the user in the past, and emphasizes and displays the extracted keywords on the search screen.

The database search supporting apparatus according to the invention may further include a keyword group database for storing a plurality of keyword groups, and the display unit has a keyword group selecting unit for selecting a specific keyword group from the keyword group database on the basis of the identification information that is input, and the display unit displays the specific keyword group selected by the keyword group selecting unit as all of options of keywords which can be input.

The database search supporting apparatus according to the invention may further include a bibliographical information search executing unit for executing a search with bibliographical information of data, and the display unit displays a set of bibliographical information selected at the time of a search and the number of data pieces including the bibliographical information on the search screen, and displays the number of AND search data pieces including both of the selected keyword and the input bibliographical information, and the number of AND search data pieces changes interlockingly with a change in the bibliographical information and the keyword.

According to the present invention, there is provided a database registration supporting method for controlling an apparatus including a database and a display unit and supporting the user to register data into a database so as to associate the data with a keyword, the apparatus executes: a step of simultaneously displaying all of options of keywords which can be input on a data registration screen and encouraging the user to select any of the keywords; a step of accepting the selected keyword; and a step of registering the data in the database so as to associate the data with the keyword.

According to the present invention, there is provided a database registration supporting method for controlling an apparatus including a database and a display unit and supporting the user to register data into a database so as to associate the data with a keyword, and the apparatus executes: a step of presenting a data registration screen and simultaneously displaying all of options of keywords which can be input on the data registration screen; a step, when a displayed option is clicked, which recognizes that the option is selected as a keyword; and a step of registering the data in the database so as to be associated with the selected keyword.

In the database registration supporting method according to the invention, the apparatus may further execute a step of encouraging input of user identification information, and the display unit executes a step of presenting the data registration screen by referring to the identification information that is input.

In the database registration supporting method according to the invention, the apparatus may execute a step of referring to the keyword use history on the basis of the identification information that is input, extracting predetermined number of keywords in the decreasing order of use frequency from the keywords used for registration by the user in the past, and emphasizing and displaying the extracted keywords on the registration screen.

In the database registration supporting method according to the invention, the apparatus may further include: a step of selecting a specific keyword group on the basis of the identification information that is input, and displaying the specific keyword group as all of options of keywords which can be input.

According to the invention, there is also provided a database search supporting method for controlling a database and a display unit and supporting the user to retrieve data stored in a database by using a keyword, and the apparatus executes: a step of simultaneously displaying all of options of keywords which can be input on a data search screen, encouraging the user to select any of the keywords and, when a keyword is selected, displaying a set of the selected keyword and the number of pieces of data including the keyword on the search screen; and a step of starting a search with the selected keyword in response to a search start request.

According to the invention, there is also provided a database search supporting method for controlling an apparatus including a database and a display unit and supporting the user to retrieve data stored in a database by using a keyword, and the apparatus executes: a step of simultaneously all of options of keywords which can be input on the data registration screen, when a displayed option is clicked, recognizing that the option is selected as a keyword, and displaying a set of the selected keyword and the number of data pieces including the keyword on the search screen; and a step of starting a search with the selected keyword in response to a search start request.

The database search supporting method according to the invention may further execute a step for encouraging input of user identification information, and the display unit executes a step of presenting the data search screen by referring to the identification information that is input.

In the database search supporting method according to the invention, the display unit may further execute a step of referring to the keyword use history on the basis of the identification information that is input, extracting predetermined number of keywords in the decreasing order of use frequency from the keywords used for searches by the user in the past, and emphasizing and displaying the extracted keywords on the search screen.

In the database search supporting method according to the invention, the apparatus may further execute a step of selecting a specific keyword group from the keyword group database on the basis of the identification information that is input, and the display unit may execute a step of displaying the specific keyword group selected by the keyword group selecting unit as all of options of keywords which can be input.

An apparatus having the functions of the database registration supporting apparatus and the database search supporting apparatus is also effective as a mode of the present invention. Further, an arbitrary combination of the components, and embodiments obtained by changing the expression of the invention among apparatus, system, recording medium, computer program, and the like are also effective as modes of the present invention. Such examples will be described below.

According to the invention, there is provided a graphical user interface for supporting the user to register data into a database so as to associate the data with a keyword, characterized in that a data registration screen is displayed on a display unit, all of options of keywords which can be input are simultaneously displayed on the data registration screen; and when a displayed option is clicked, it is recognized that the option is selected as a keyword.

According to the invention, the graphical user interface is characterized in that a input of a registrant registering data into the database is accepted, the database is referred to, predetermined number of keywords are extracted in the decreasing order of use frequency from the keywords used for registration by the registrant in the past, and the extracted keywords are emphasized and displayed.

According to the invention, there is also provided a graphical user interface for supporting the user to retrieve data stored in a database by using a keyword, characterized in that a database search screen is displayed on a display unit, all of options of keywords which can be input are simultaneously displayed on the database search screen, when a displayed option is clicked, it is recognized that the option is selected as a keyword, and a set of the selected keyword and the number of data pieces including the keyword is displayed on the search screen.

According to the invention, there is also provided a graphical user interface characterized in that an input of a searcher is accepted, the database is referred to, predetermined number of keywords are extracted in the decreasing order of use frequency from the keywords used for search by the user in the past, and the extracted keywords are emphasized and displayed.

According to the invention, there is also provided a graphical user interface characterized in that an input of a data registrant is accepted, the database is referred to, predetermined number of keywords are extracted in the decreasing order of use frequency from the keywords used for data registration by the user in the past, and the extracted keywords are emphasized and displayed.

According to the invention, an apparatus for controlling the graphical user interface is also provided. As such an apparatus, there is an apparatus including: a display unit for displaying a data registration screen, and a display managing unit for simultaneously displaying all of keywords which can be input on the data registration screen and, when a displayed option is clicked, it is recognized that the option is selected as a keyword. The apparatus further includes: registrant input means for accepting an input of a registrant for registering data into a database; keyword storing means for storing a keyword used at the time of data registration by registrant; and keyword extracting means for recognizing the registrant accepted by the registrant input means and extracting predetermined number of keywords in the decreasing order of use frequency of the registrant. The display managing unit may emphasize and display the extracted keyword.

As an apparatus for controlling the graphical user interface, there is also an apparatus including: a display unit for displaying a data search screen, and a display managing unit for simultaneously displaying all of keywords which can be input on the data search screen, when a displayed option is clicked, recognizing that the option is selected as a keyword, and displaying a set of the selected keyword and the number of data pieces including the keyword on a search screen. The apparatus further includes: searcher input means for accepting an input of a searcher searching a database for data; keyword storing means for storing a keyword used at the time of data search by searcher; and keyword extracting means for recognizing the searcher accepted by the searcher input means and extracting predetermined number of keywords in the decreasing order of use frequency of the searcher. The display managing unit may emphasize and display the extracted keyword. The apparatus further includes: search data registrant input means for accepting an input of a registrant of data to be retrieved; registrant-by-registrant keyword storing means for storing keywords used at the time of data registration by registrant; and keyword extracting means for recognizing the data registrant accepted by the data registrant input means and extracting predetermined number of keywords in the decreasing order of use frequency of the registrant. The display managing unit may emphasize and display the extracted keyword.

According to the invention, there is also provided a recording medium in which the database registration supporting program is stored.

According to the invention, there is also provided a recording medium in which the database registration supporting program is stored.

A recording medium in the invention denotes a medium such as a magnetic disk, an optical disk, or a magnetooptic disk.

Further, according to the invention, there is also provided a database search/registration supporting apparatus for supporting data search and registration of data on a database, including: a database for storing data; a keyword storing unit for storing a keyword group used at the time of search of the data and registration of the data so as to be associated with an organization code specifying an organization to which the user belongs; a user data obtaining unit for obtaining the organization code from the user; a keyword obtaining unit, when a data search request or a data registration request from the user is accepted, for referring to the organization code obtained and obtaining a keyword group corresponding to the organization code from the keyword storing unit; a display unit for presenting the keyword group to the user; and a data processor, when a predetermined keyword is designated from the keyword group displayed, for performing a data search or a data registration by using the keyword.

The display unit may display the keyword group as all of options of keywords that can be input.

The database search/registration supporting apparatus may further include a keyword switching unit for switching a keyword group displayed to another keyword group in accordance with a user's request.

In the database search/registration supporting apparatus, the keyword switching unit may include a determining unit for determining whether the user's request can be addressed or not.

“Data” stored in the database in the invention may be various data such as data including a document or a figure. In particular, in the case of using data having the property of accumulation for long period and data which has to be dealt promptly, the effects of the present invention are more conspicuous. Examples of such data are technical reports, sales materials, trouble reports, consulting reports, business trip reports, safety management materials, operation management materials for plants, equipment, and the like, medical records, patent information, and judgment information.

In the case of applying the present invention to handling of technical reports, the following effects are obtained. At the time of preparing a technical report, many academic document and reports have to be cited. Particularly, at the time of preparing a report of countermeasures against troubles, not only reports in the past but also manuals have to be referred to. Much time and manpower is necessary to obtain such materials and, because of this, it takes long time to prepare a report. On the other hand, technical reports, particularly, reports including countermeasures against troubles are required to be provided promptly. It is important to obtain necessary materials promptly and reliably and attach them to a report. According to the present invention, such a problem can be solved with reliability. Thus, it is very effective to apply the present invention to handling of technical reports.

In the case of applying the present invention to sales materials, sales activity histories, the know-how, and the like of previous persons in charge, persons in charge in other sections in the company are shared. Consequently, efficient sales activities can be developed.

According to the invention, all of options of keywords are displayed on the same screen. Consequently, the options can be compared with each other, and a proper option as a keyword can be selected promptly and accurately. By executing searches a plurality of times, the positions of keywords in a display screen are grasped naturally, so that time to find a keyword is largely shortened.

Since all of the options can be grasped at a glance, at the time of entering keywords, the user can enter a plurality of keywords with light load. As a result, many keywords can be easily associated with data registered in a database, and a usable database can be constructed. In the conventional method of selecting a keyword from a pull-down menu frequently used for entering keywords to a database and entering the keyword, in the case of entering a plurality of keywords in different categories, time and manpower is necessary to open some pull-down menus and find a desired keyword until the keyword is found. Therefore, willingness to enter many keywords, of the database registrant (keyword entering person) deteriorates, and there is a tendency that the registrant finishes a registering work after he/she enters one or two keywords. In contrast, according to the present invention, all of options of keywords are displayed on the same screen and a desired keyword can be found quickly, so that a usable database in which a number of keywords are entered is constructed. In the invention, all of options are simultaneously displayed on the same screen. All of options denote here substantial options used for search or registration.

In the invention, by using the method of encouraging the user to enter identification information and presenting a screen according to the identification information, a keyword search/registration screen adapted to the user can be presented. Since one of purposes of construction of a knowledge management system using keywords is to share the know-how of people, at the time of introducing the system into a company, in many cases, introduction of the system to the whole company is the precondition. On the other hand, keywords used at the time of storing data are largely different from each other among sections. Consequently, at the time of keyword search and registration of report documents using keywords, it is efficient to use templates different from each other among sections. The present invention relates to a system satisfying such a demand. For example, a screen in which keywords frequently used by the user or a section to which the user belongs are selected or emphasized and displayed can be presented, so that efficiency of a keyword search and a keyword registration improves. The identification information of the user is not limited as long as it is information capable of specifying the user or a section to which the user belongs.

The database registration supporting apparatus according to the present invention may further include registration mode designation accepting means for accepting designation of a registration mode, and the display unit may display a registration screen corresponding to the designated registration mode.

The database search supporting apparatus according to the present invention may further include search mode designation accepting means for accepting designation of a search mode, and the display unit may display a search screen corresponding to the designated search mode.

Further, according to the invention, there is also provided a report preparation supporting apparatus for supporting preparation of a report made by a report preparing person and electronically storing report information of a prepared report, including: a database for electronically storing report information; and a report preparing unit for accessing the database, presenting the report information to the report preparing person, preparing a report in accordance with an instruction of the report preparing person, and registering report information of the report into the database, and the report preparing unit includes: a search processing unit for accepting an input of a keyword selected from keyword options displayed on a keyword search screen, and presenting the report information of a report corresponding to the keyword, stored in the database; and a registration processing unit for accepting an input of the keyword selected from the keyword options displayed on a keyword input screen, preparing a report including, as report information, the accepted keyword, materials created by the report preparing person, and report information designated by the report preparing person out of the report information presented by the information presenting unit, and after preparation of the report, storing the report information into the database without receiving a request from the outside.

According to the invention, there is also provided a report preparation supporting program for controlling an apparatus for supporting preparation of a report by a report preparing person and electronically storing report information of a prepared report into a database, and making the apparatus execute: a step of accepting an input of a keyword selected from keyword options displayed on a keyword search screen and presenting report information of a report corresponding to the keyword; and a step of accepting an input of a keyword selected from keyword options displayed on a keyword input screen, preparing a report including, as report information, the accepted keyword, materials created by the report preparing person, and report information designated by the report preparing person out of the report information presented by the information presenting unit, and after preparation of the report, storing the report information into the database without receiving a request from the outside.

According to the invention, once a report preparing person enters report information, the supporting apparatus automatically prepares a report, so that manpower for preparing a report is conspicuously reduced. Since a report in a predetermined format is created, easy-to-read reports are formed in the uniform format even when different persons in charge create them.

In addition to materials generated by a report preparing person, report information obtained from a database by a search is properly added to prepare a report. Consequently, accumulation of know-how can be utilized for preparation of reports. A prepared report is associated with a keyword and stored in the form of report information into a database, so that know-how is further accumulated. As described above, a report is prepared while using the know-how and the result of preparation is accumulated as the know-how, so that configuration and effective use of a database are integrated and excellently realized.

According to the invention, after a report is generated, without receiving a request from the outside, report information is stored into a database. That is, once a report is prepared on the basis of the report information, the report information is automatically stored into the database, so that manpower for entering information to a database is not necessary in addition to the preparation of a report. Therefore, without forcing an extra load to a person in charge, a database can be constructed smoothly.

In the invention, the report information denotes information constructing a report. For example, the report information may have a configuration including document information including contents of a report, bibliographical information of the report, and a keyword associated with the report. When there are materials related to a report, a configuration further including link information of materials related to the report may be employed. By including the link of the related materials of the report in the report information, the document information including the contents of the report can be made concisely. The ideation to reach the conclusion of the report can be easily understood. Not only the manpower to enter information to a database but also the manpower itself of preparation of a report are reduced, and hand-down of the know-how is also facilitated.

In the present invention, each of the keyword search screen and the keyword input screen can be a screen on which all of options of keywords are displayed.

The keyword option displayed on the keyword search screen and the keyword option displayed on the keyword input screen may coincide with each other.

Further, in the in the report preparation supporting apparatus, the report preparing unit obtains a number corresponding to the report preparing person and, after that, presents the keyword search screen and the keyword input screen including keyword options according to an organization to which the report preparing person belongs in consideration of the obtained number.

With the configuration, a keyword can be reliably given, and efficiency of a keyword search also improves.

In the invention, an authorizer access unit for presenting predetermined information to an authorizer who authorizes the report may be also provided. After preparation of a report, the report preparing unit notifies the authorizer access unit of completion of preparation of the report and input of the report information into the database without receiving a request from the outside. With the configuration, approval on a report cannot be obtained without entering the data into a database, so that accumulation of data into the database is executed certainly.

In the invention, the search processing unit may include an owner attribute giving unit for giving owner attributes of the report preparing person to the report information presented and storing the resultant report information into the database in accordance with a request from the report creating person. With the configuration, the report information stored in the database can be more effectively used.

In the invention, the search processing unit may include a related material attribute giving unit for giving related material attributes to the report information presented and storing the report information into the database in accordance with a request of the report preparing person, and the registration processing unit accesses the database, extracts report information to which the related material attributes are given, and creates a report including the extracted report information. With the configuration, report information stored in the database can be more effectively used.

Further, an arbitrary combination of the components, and embodiments obtained by changing the expression of the invention among apparatus, system, recording medium, computer program, and the like are also effective as modes of the present invention.

As described above, according to the invention, efficiency at the time of executing keyword entry and keyword search on a database is largely improved, so that the degree of utility of the database and the system improves dramatically. Consequently, accumulation of data in a database naturally progresses while using the database and the system, so that the degree of utility of the database and the system improves more. As a result, the useful and easy-to-use database and system are efficiently constructed.

In a mode of the present invention, once a report preparing person enters report information, a report is automatically prepared, so that manpower for preparing a report is conspicuously reduced. Since a report is created on the basis of report information and the report information is stored into a database, manpower for entering information to a database is largely reduced. As a result, without forcing an extra load to a person in charge, a database can be constructed smoothly.

### BRIEF DESCRIPTION OF THE DRAWINGS

The above and other objects, features, and advantages will become more apparent from the following description of preferred embodiments and accompanying drawings.

FIG. 1 is a schematic configuration diagram of an apparatus of an embodiment.

FIG. 2 is a diagram showing an example of an inquiry form.

FIG. 3 is a diagram showing an inquiry state table.

FIG. 4 is a diagram showing an inquiry state detailed form.

FIG. 5 is a diagram showing an example of a keyword search screen.

FIG. 6 is a diagram showing a report input screen.

FIG. 7 is a diagram showing a report input screen.

FIG. 8 is a diagram showing an example of a report data registration screen.

FIG. 9 is a diagram showing an example of a consulting report made.

FIG. 10 is a diagram showing a data structure of report information.

FIG. 11 is a system configuration diagram including a database searching unit, a report preparing unit, and databases.

FIG. 12 is a diagram showing the procedure of a report preparation supporting method described in an embodiment.

FIG. 13 is an apparatus configuration diagram for realizing a graphical user interface.

FIG. 14 is a diagram showing an example of a keyword search screen.

FIG. 15 is a diagram showing an example of a report data registration screen.

FIG. 16 is a schematic configuration diagram of a search supporting apparatus according to the invention.

FIG. 17 is a screen flow of a report preparation work managing function realized by the search supporting apparatus shown in FIG. 16.

FIG. 18 is a diagram showing search execution buttons and search result display boxes in FIG. 20 and the like.

FIG. 19 is a diagram showing an example of the keyword search screen.

FIG. 20 is a diagram showing a keyword search result table.

FIG. 21 is a diagram showing an example of a general search screen.

FIG. 22 is a diagram showing an AND search result table.

FIG. 23 is a diagram showing an example of the keyword search screen.

FIG. 24 is a diagram showing an example of a report input/edit screen.

FIG. 25 is a diagram showing a related database table.

FIG. 26 is a diagram showing a flow in a third embodiment.

FIG. 27 is a diagram showing an example of an apparatus according to the invention.

FIG. 28 is a diagram showing an example of data stored in a database used for the apparatus according to the embodiment.

FIG. 29 is a diagram showing an example of data stored in a database used for the apparatus according to the embodiment.

FIG. 30 is a diagram showing an example of data stored in a database used for the apparatus according to the embodiment.

FIG. 31 is a diagram showing an example of data stored in a database used for the apparatus according to the embodiment.

FIG. 32 is a diagram showing an example of the keyword search screen.

FIG. 33 is a diagram showing the concept of configuration of a knowledge management system using keywords.

FIG. 34 is a diagram showing an example of the keyword search screen.

FIG. 35 is a diagram showing the configuration of a search/registration support system according to an embodiment.

FIG. 36 is a diagram showing the configuration of a report preparation supporting apparatus according to an embodiment.

FIG. 37 is a diagram showing an example of the detailed configuration of the apparatus illustrated in FIG. 36.

FIG. 38 is a diagram showing an example of a report record.

FIG. 39 is a diagram showing a screen on which an owner registration and a pickup process are performed.

### BEST MODE FOR CARRYING OUT THE INVENTION

The present invention employs a method of displaying keywords on a screen. The method is suited to an information sharing tool for experts. The point will described hereinbelow.

(i) Fuzzy Search and Natural Language Search

Search methods widely used in recent years include “fuzzy search” and ‘natural language search’ capable of making a search even if the user does not know expert keywords. The “fuzzy search” is a method of generating a dictionary of synonyms (for example, PC, personal computer, pasokon (in Japanese)) and retrieving target data with reliability. The “natural language search” is a searching method of analyzing a sentence and retrieving data having contents close to a sentence to be retrieved. The searching methods are born and grown in the world of the Internet used by an unspecified number of general users. The methods use the advanced technology of IT and are effectively used when a user having no expert knowledge makes a search for expert information. In the case where an expert makes a search for information of his/her specialty, however, there is the following inconvenience. Knowledge management systems whose sales points are those functions are often expensive, and there are not many cases that a small section can purchase the knowledge management system. The tool is purchased by a headquarter or a company. As a result, a large amount information other than special information of an organization is also accumulated. Consequently, when “fuzzy search” or the like is used, a large amount of data other than desired expert data is extracted. An exert user judges that the system is not useful for him/her, and tends not to use the system.

(ii) Full Text Search

The full text search is a most common searching method having long history. The system also has the search function. In this case, terms used vary among individuals. For example, in the case of making a search for data regarding titanium, terms such as “Chitan (in Japanese)”, “Chitan (in Japanese (single-width mode)), “Chitanium (in Japanese)”, “TITANIUM”, “Ti”, “Chitanium Gokin (in Japanese)”, and “Chitania (in Japanese) can be used for a search. Search results vary according to a term used for the full text search. A result that only about 20% of whole information regarding titanium is extracted is obtained in the past use records of the inventors herein. Consequently, expert users do not feel like using the system. If a unified keyword of “Ti alloy” is used, all of related data can be extracted.

(iii) Normal Keyword Search

A search with a keyword is effective at extracting desired data with reliability. However, in a normal keyword search such as a document search of JICST, there are too many expert terms, a number of similar keywords exist, further, the number of keywords is large, and a hierarchical structure is employed. Consequently, at the time of data registration/search, it is necessary to develop a term like large classification, intermediate classification, and small classification in order to find a keyword which seems to be relevant. Since usability of such a structure is low, most of data registrants are satisfied when they register a few keywords which are found by chance. As a result, related keywords are not satisfactorily assigned to each piece of data. Therefore, it frequently happens that a data reader makes a keyword search but cannot extract desired data.

In a search in a hierarchical structure, if the user does not understand the policy of the configuration of the hierarchy itself and the concept of classifications, he/she cannot go down to the lower levels in the hierarchy with certainty. Further, there is also a case such that at the time point the user finds he/she is in a wrong branch, the user cannot judge where to return and is lost in the forest of the hierarchy. In an information search in science technology document in which the study system is complicated and the number of interdisciplinary studies increases, a hierarchical search is difficult even for an expert who knows the study system to a certain degree.

In contrast, by displaying selected keywords in a screen, the following effects are obtained.

(i) By using the keyword registration/search screens a plurality of times, the user remembers the positions of keywords as an image.

(ii) Since necessary keywords are narrowed down, an inputting operation is also simple.

(iii) If a keyword by which a screen can be displayed can be optimized, a data registrant feels like entering all of the keywords (psychological effect of human).

(vi) Since the number of keywords to be added to data is not limited, the user can register keywords the user is not so sure if they are right ones only by clicking.

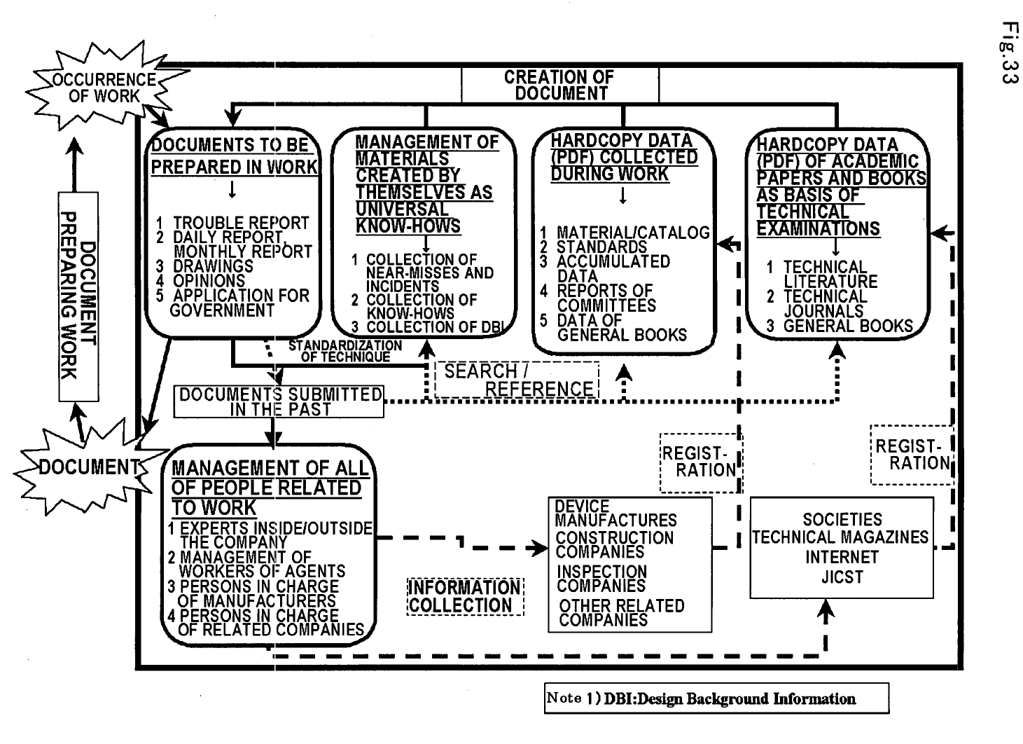

FIG. 33 is a diagram showing the concept of configuration of a knowledge management system using keywords, as an object of the present invention. According to the invention, at the same time a document is created, the document is accumulated in a predetermined database, and sharing of knowledge is realized easily. The configuration of such a knowledge management system can be applied to various fields as shown in FIG. 33.

In the present invention, a configuration in which keywords matching a registrant, a searcher, or the like and having high use frequency of the registrant, searcher, or the like are extracted and are displayed in an emphasized manner on the registration screen or search screen. With the configuration, the manpower of entry and search can be largely reduced. In this case, various emphasis display forms can be employed. For example, methods of giving background color to a corresponding keyword, displaying the characters of a keyword in a color different from the other characters, displaying characters of a keyword in reverse video (reverse display of the character color), giving a mark to the side of a keyword, making the characters of a keyword blink, and the like can be also employed. A method of providing a check box on the side of a keyword so that the user can mark the check box of a keyword frequently used or the use frequency rank is displayed in the check box can be also employed.

Except for the emphasis display of a keyword frequently used, for example, a registrant or a searcher may customize keywords to be emphasis-displayed.

In the invention, a configuration in which a plurality of keywords are classified into some fields and grouped may be also used. In such a configuration, at the time of entering a keyword, the user can be further encouraged to enter a plurality of keywords.

A configuration in which a reference table of keywords is generated and identification number is given to each of the keywords may be also employed. In the reference table, a keyword in Japanese and a keyword in a foreign language such as English are stored in correspondence with the identification number. With such a configuration, one database can be used for reports in both Japanese and the foreign language. For example, when a keyword in Japanese is designated, a keyword in the foreign language such as English can be simultaneously displayed on a search screen.

In the case of displaying all of options of keywords on the same screen, it is important to sufficiently narrow down to a representative keyword. It is important to make one keyword represented by a plurality of terms of the same meaning and display the keyword on a screen. It is also important to determine the range of categories of a keyword in consideration of the property of data to be stored in a database. For example, in the case of a database of technical reports on the welding technique, with the keyword of “welding”, most of the reports are hit, so that the keyword is useless. It is therefore necessary to select a subordinate and detailed keyword in the subordinate concept of “welding”. With such consideration, a keyword is selected and displayed on a screen.

In the case of displaying all of options of keywords on the same screen, the keywords are sufficiently narrowed as a result. Thus, terms of the same meaning are prevented from being entered as keywords which vary among users, and usability of the database improves.

A preferred embodiment of the present invention will now be described with reference to the drawings.

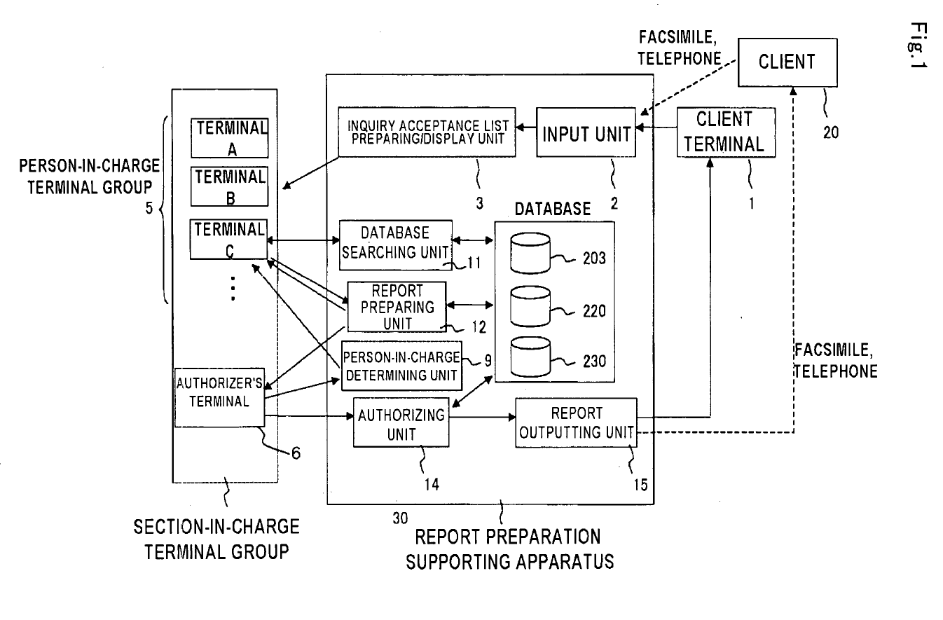

FIG. 1 shows an example of a report preparation supporting apparatus according to the present invention. A report preparation supporting apparatus 30 in FIG. 1 supports preparation of a report by a person in charge (a terminal C in the embodiment) and electronically stores report information constructing a prepared report into a main database 203, a company information database 220, and an individual information database 230. The report information denotes here various information constructing a report and includes, for example, document information including the contents of a report, bibliographical information of the report, and keywords associated with the report. In the case where there are related materials of the report, link information of the related materials of the report may be also included. Concrete contents of the report information are, for example, as follows.

(i) information such as a trouble report, a consulting report, a business trip report, and a proceeding

(ii) materials for inquiries and know-how

(iii) materials of other companies' techniques, company catalog, and materials distributed at conferences

(iv) information such as scientific paper and academic paper

(v) inquiry mail from client

(vi) keyword related to a report

The information is stored in the form of a document and an image into the database.

The configuration of the report preparation supporting apparatus 30 is realized by, as hardware, a CPU, a memory, other LSI, and the like of an arbitrary computer, and is realized by, as software, a loaded program having a data processing function of a memory. In the diagram, function blocks realized by the linkage of them are drawn. Therefore, the function blocks can be realized in many forms only by the hardware, only by the software, or combination of the hardware and software. The report preparation supporting apparatus 30 may be of a stand alone type or a dispersion type in which a plurality of apparatuses are connected to each other via a network.

### First Embodiment

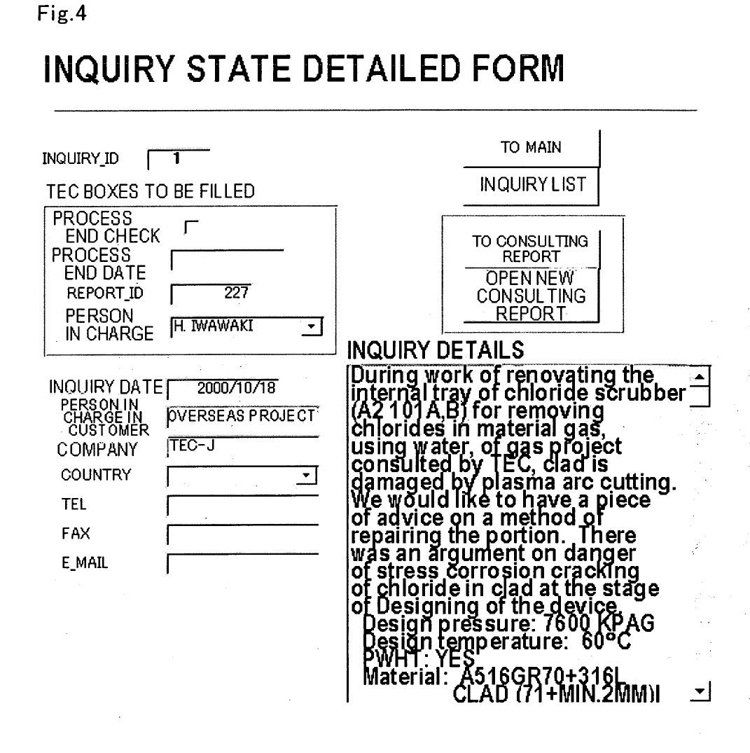

A first embodiment will be described hereinbelow with reference to the drawings. In the embodiment, the flow in which a report for an inquiry from a client is prepared by a person in charge and authorized and, after that, the report is sent to the client will be described as an example. The inquiry is asking for advice on a method of repairing a member (FIG. 4).

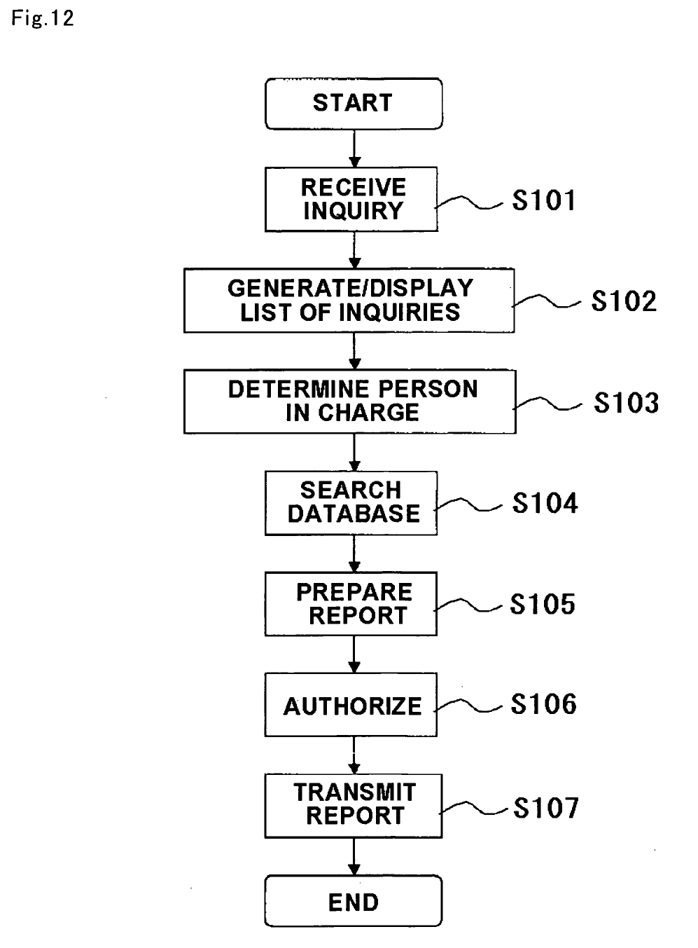

The main procedure in the embodiment is as shown in FIG. 12. First, an inquiry is received (S101) and, after that, an inquiry acceptance list is generated and displayed on terminals of people concerned (S102). A predetermined person having a supervisory duty determines a person in charge (report preparing person) on the basis of the data displayed (S103). The person in charge searches a database included in a supporting apparatus according to the present invention and collects necessary information (S104) and, on the basis of the information, prepares a report (S105). The report is automatically prepared by the supporting apparatus on the basis of predetermined report information that is input by the person in charge. That is, the supporting apparatus places the report information on a predetermined template and arranges the report in a form of a report. After that, the report is authorized (S106) and is sent (S107).

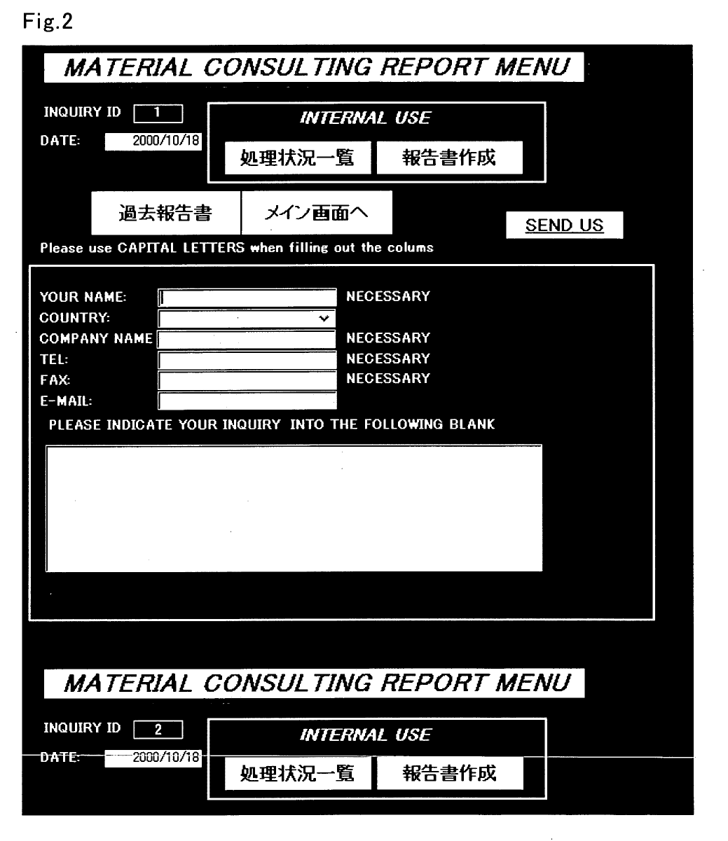

The embodiment will now be described with reference to FIG. 1. First, in FIG. 1, an inquiry from a client is input to an input unit 2. As the form of an input, a method of inputting an inquiry by an e-mail or the like from a client terminal 1, a method of inputting information received by a facsimile, telephone or the like from a client 20 to the input unit 2 by an operator, or the like can be employed. In the case of receiving an inquiry by an e-mail, for example, by preparing a blank form as shown in FIG. 2 and receiving an inquiry in this form, it becomes convenient to handle data afterwards.

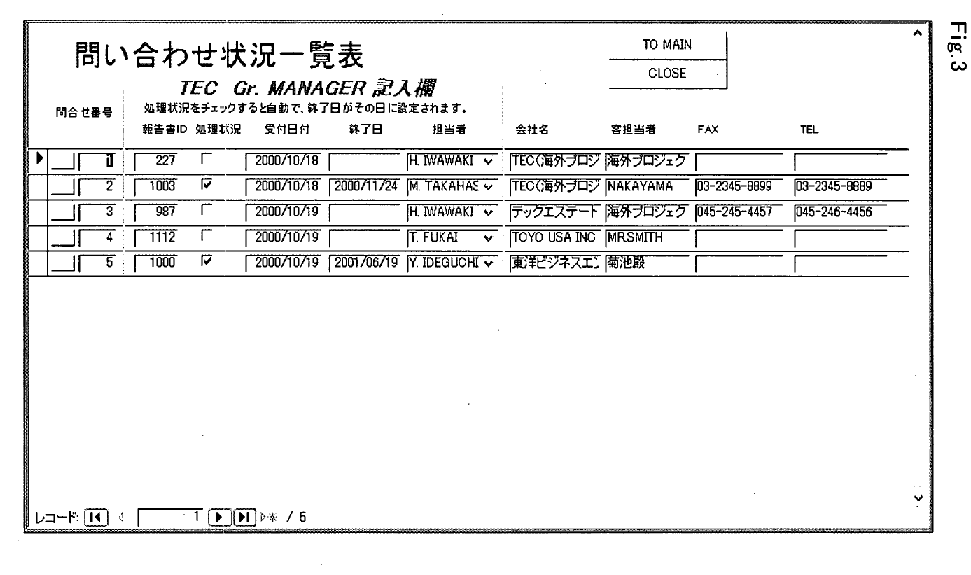

An inquiry input to the input unit 2 is stored in a not-shown storing unit and also transmitted to an inquiry acceptance list preparing/display unit 3 where it is included in a list together with other inquiries. FIG. 3 is a diagram showing an example of the list. The list is displayed on the screen of each of terminals A, B, C, . . . constructing a person-in-charge terminal group 5, and an authorizer's terminal 6.

Although persons in charge are input for all of inquiries in the list of FIG. 3, at the stage just after an inquiry is received, the person-in-charge box is blank. The authorizer recognizes from the list that a new inquiry is received, determines a person in charge, and inputs the person in charge in a person-in-charge determining unit 9. The person in charge whose name is input is notified of the fact by a confirmation mail or the like that he/she was assigned as a person in charge for the inquiry. In the example of FIG. 1, the person corresponding to the terminal C is the person in charge of the inquiry (hereinbelow, simply called a person in charge).

First, the person in charge clicks a button positioned on the most left side in the list of FIG. 3 to recognize the details of the inquiry and opens an inquiry state detailed form shown in FIG. 4. In the form, in addition to the date of the inquiry and bibliographical items such as the person in charge in the customer company, the e-mail is displayed as it is in the box of the inquiry details. The person in charge recognizes the contents and searches a database via a database searching unit 11 for an old inquiry similar to the inquiry. The database search can be made by using report ID number, date, the name of the person in charge, and the like or with a keyword.

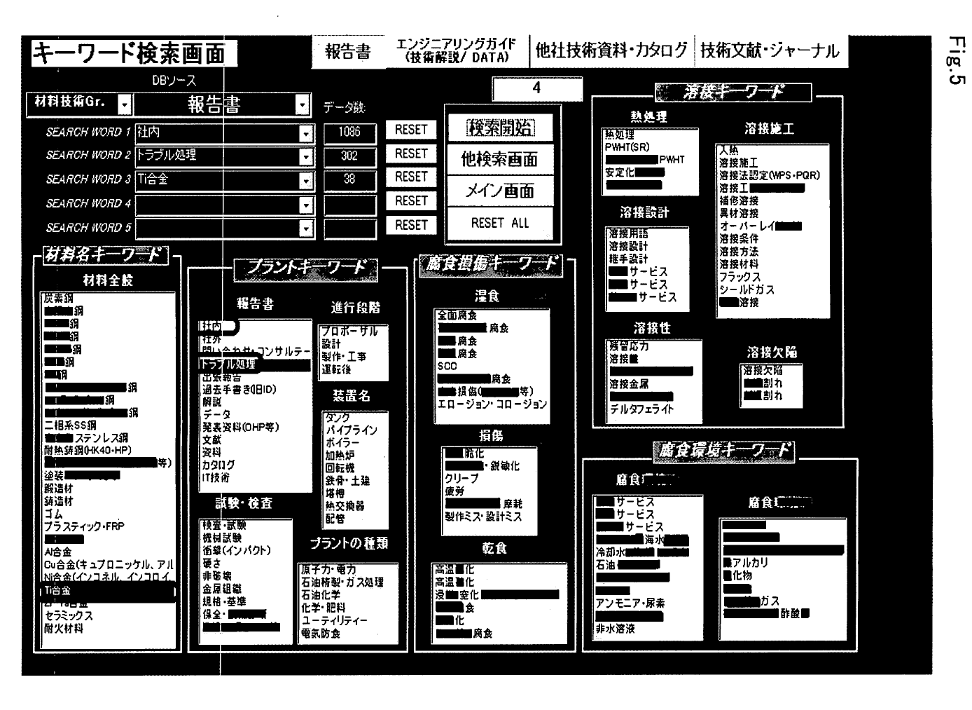

In the embodiment, a keyword search is performed on the screen shown in FIG. 5. The screen shows a state in which a keyword is selected, and the selected keyword and the number of pieces of data including the keyword are displayed as a set (in the left upper part of the screen).

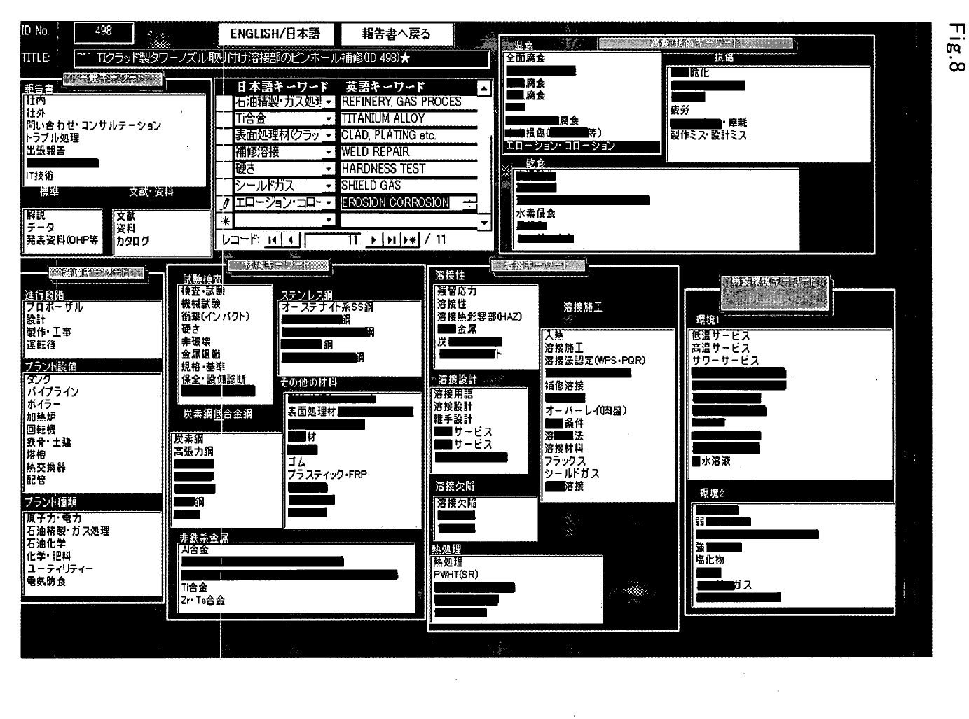

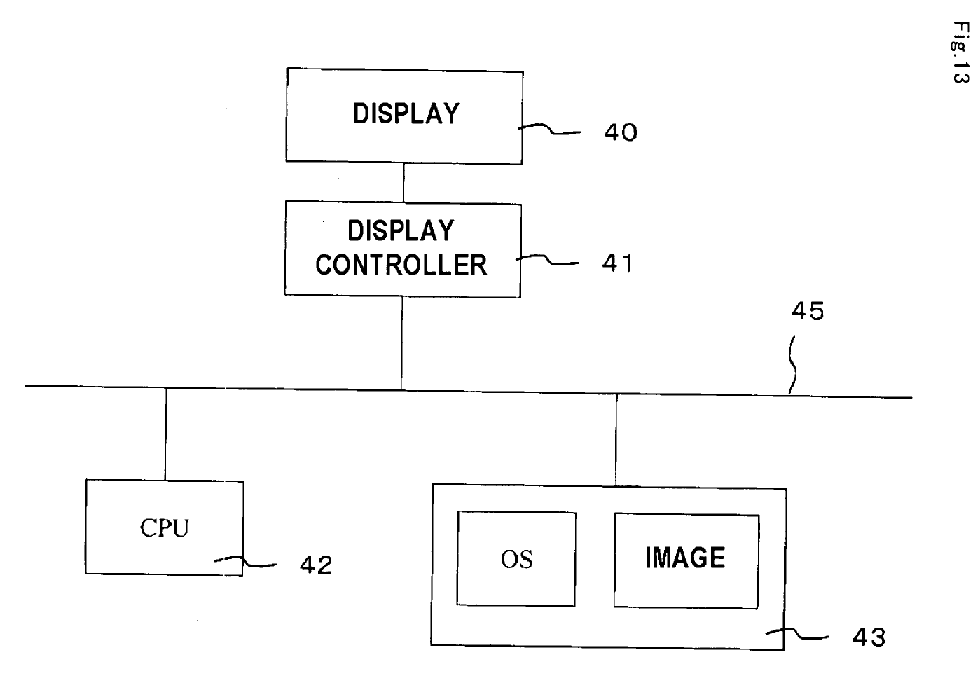

The search screen is realized by a graphical user interface having a specific configuration and a program. The configuration of an apparatus for displaying such a screen is shown in FIG. 13. In FIG. 13, a CPU 42, a storage (ROM, RAM, hard disk, or the like) 43, and a display controller 41 are connected to a bus 45. As such an apparatus, various general information processors such as a general computer can be used. Although some of keywords are erased in FIG. 5, they are not erased in an actual screen (also in FIGS. 8, 14, and 15 which will be described later).

The apparatus shown in FIG. 13 can be connected to another apparatus such as database control means and various databases via a network. For example, in FIG. 1, an apparatus including the configuration shown in FIG. 13 may be used as each of the terminals, and the report preparation supporting apparatus 30 may be connected to the apparatuses via a network.

Referring again to FIG. 13, an operating system (OS) and various programs are stored in the storage 43 and an area for storing images and the like is provided in the storage 43.

The display controller 41 reads display images in the storage 43 in predetermined cycles and outputs them to the display 40 (display in each of the terminals in FIG. 1). With the configuration, the graphical user interface of the present invention is realized.

The data search screen is displayed on the display 40. In the data search screen, all of keywords which can be input are simultaneously displayed on the same screen. When an option displayed on the screen is clicked, it is recognized that the option is selected as a keyword, and a set of the selected keyword and the number of pieces of data including the keyword is displayed on the search screen. A series of steps is realized by a GUI application stored in the storage 43 or the like.

By the GUI application stored in the storage 43, a keyword having high use frequency is presented for each searcher as described above and a keyword having high use frequency can be presented for each data registrant. The keywords can be also displayed so as to be emphasized. The steps are realized by cooperation between the databases, the database controller, and the like connected to the apparatus group.

The search screen of the embodiment is different from that in the conventional document with respect to the following points.

First, all of options of keywords are displayed on the same screen. The conventional search screen widely uses a form in which the user freely enters a keyword, a form in which candidates are displayed in a pull-down menu, a form in which selection windows of different concepts are open like the major concept, the middle concept, and the minor concept and the user selects a keyword from the windows, a method obtained by combining the forms, and the like. By such methods, a search can be executed with various keywords, and there is a problem that an operation of entering a keyword is complicated. In the case where all of keywords cannot be grasped at a glance and, in particular, the method of sequentially opening selection windows of different concepts is employed, manpower is required for an operation of moving to a collateral menu, and the user has to perform an inconvenient and confusing work.

An object of the invention places importance on convenience of operations so that a search screen in the form as described above is employed. When all of keywords are displayed on the same screen as described above, by executing a search a plurality of times, the positions of the keywords in the display screen are naturally grasped and, because of the visual effect, the time require to find a keyword is largely reduced.

In the search screen, a plurality of keywords are divided in some fields and group. The keywords of different concepts such as the major concept, middle concept, and minor concept are displayed in parallel on the same screen. Such a display can encourage the user to enter a plurality of keywords in different categories.

A reference table is prepared for a keyword, and an identification number is given to each keyword. In the reference table, a keyword in Japanese and a keyword in English are stored for each identification number. Consequently, when a keyword in Japanese is designated, a keyword in English is simultaneously displayed on the search screen.

Since keywords are managed by the identification number of the reference table, the invention can easily deal with the case of increasing the number of languages in a database. For example, in the case of changing the configuration of a database including thousands of pieces of registered data so that the database can be searched also with French, it can be achieved only by providing a field for French in the reference table of keywords and entering French words corresponding to the keywords in the fields. An operation of associating data with the keyword is unnecessary. Consequently, the database can be changed to a database which can be searched with French without performing complicated operation.

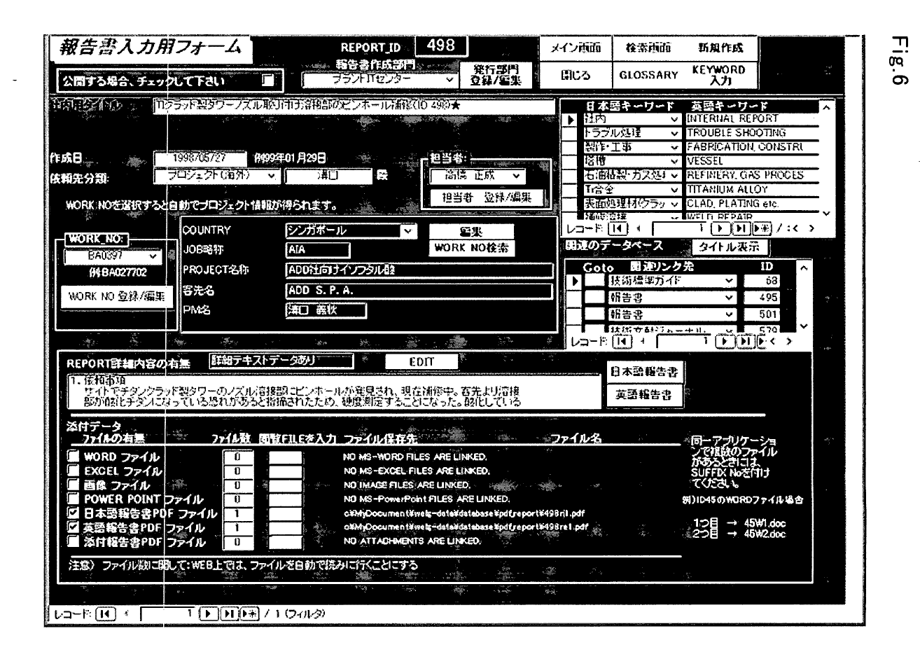

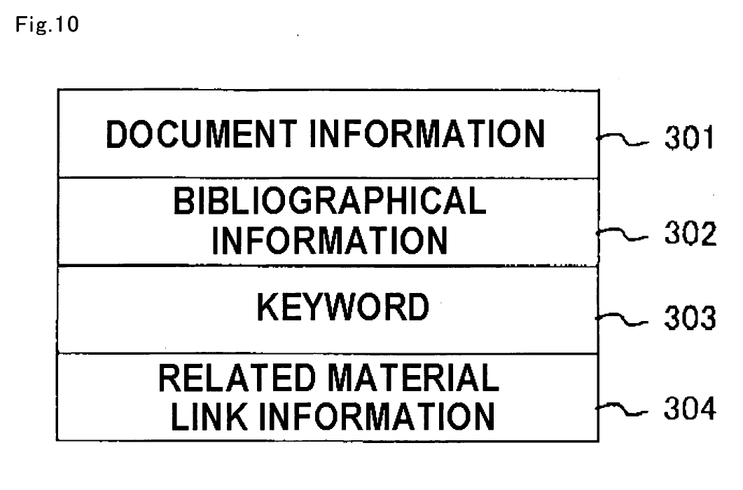

After keywords are entered as described above, a list of corresponding report documents is displayed. When any of them is selected, detailed data of a report is displayed. The data of the report information has, for example, a structure as shown in FIG. 10, that is, a structure constructed by document information 301, bibliographical information 302, a keyword 303, and related material link information 304. The document information 301 is sentence data or the like generated by the person in charge. The bibliographical information 302 includes report ID number, date, the name of the person in charge, company information of a client, and the like. The keyword 303 is a keyword entered by the person in charge. The related resource link information 304 is information including materials, supplementary resources, and the like useful to understand the report, and includes information necessary to reach the location of the materials stored in the database. FIG. 6 is an easy-to-see layout formed from the information on the same screen. The person in charge can examine a response to the inquiry from various angles in consideration of the information displayed on the screen.

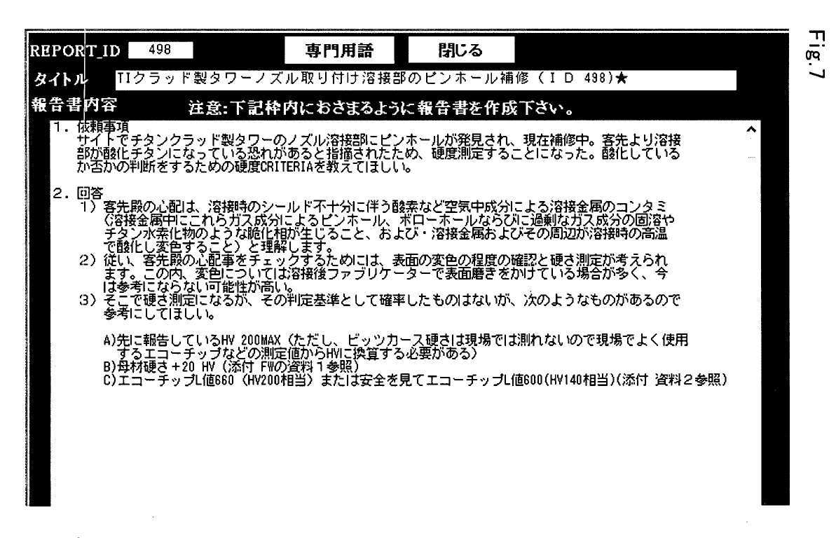

In consideration of the information, the person in charge prepares a report. A report is prepared by entering required items to the same form as that of FIG. 6. In the form, data can be entered by a pull-down menu for each of predetermined items, and it is devised so as not to bother the user as much as possible. The form shown in FIG. 6 is in a state where data has already been filled in necessary items. An actual entry work is performed as follows. For example, to enter the detailed data of a report, the button of “EDIT” in the box of “the presence or absence of the detailed data of report” is clicked. By the click, a sentence input screen as shown in FIG. 7 appears, and sentences are entered in this screen. In this form, the upper limit of the amount of sentences is determined and only points are described by short sentences. The reason why short sentences are sufficient is that the other materials cited in the item of “related database” positioned in the right part of FIG. 6 can make up for detailed data, drawings, description of related techniques, and the like. Consequently, the efforts of the person in charge can be conspicuously reduced and, moreover, an advantage that the qualities of report document are made uniform and improve is also obtained.

The document shown as the related database can be easily displayed on the screen by clicking the button of an applicable material in the box of “related database” positioned in the right part of FIG. 6. When the document is “report”, the document is displayed in the form shown in FIG. 6. In the related document, related document is also displayed. As a result, the user can see a large volume of information by links by a single search. The related links in the report can be easily entered by a method such as entry of ID number of related document. The configuration of entering the degree of relatedness to the report at the time of entering a link can be also employed. For example, a method of ranking links on a scale of A, B, and C in decreasing order of relatedness may be employed. In such a manner, the efficiency at the time of investigating related document later can be improved.

A keyword of the report can be entered on the screen of FIG. 8 which is displayed by clicking the button of “keyword input” in the upper right part of the screen of FIG. 6. The screen is realized by the graphical user interface and the program of the invention. Such screen display is realized by an apparatus configuration shown in FIG. 13 like the search screen of FIG. 5.

In FIG. 13, the CPU 42, storage (ROM, RAM, hard disk, or the like) 43, and display controller 41 are connected to the bus 45. As such an apparatus, various general information processors such as a general computer can be used.

The apparatus shown in FIG. 13 can be connected to another apparatus such as database control means and various databases via a network. For example, in FIG. 1, an apparatus including the configuration shown in FIG. 13 may be used as each of the terminals, and the report preparation supporting apparatus 30 may be connected to the apparatuses via a network.

Referring again to FIG. 13, an operating system (OS) and various programs are stored in the storage 43 and an area for storing images and the like is provided in the storage 43.

The display controller 41 reads display images in the storage 43 in predetermined cycles and outputs them to the display 40 (display in each of the terminals in FIG. 1). With the configuration, the graphical user interface of the present invention is realized.

The data registration screen is displayed on the display 40. In the data registration screen, all of keywords which can be input are simultaneously displayed on the same screen. When an option displayed on the screen is clicked, it is recognized that the option is selected as a keyword, and the selected is displayed on the registration screen. A series of steps is realized by a GUI application stored in the storage 43.

By the GUI application stored in the storage 43, a keyword having high use frequency can be presented for each of registrants as described above and a keyword can be also displayed so as to be emphasized. The steps are realized by cooperation between the databases, the database controller, and the like connected to the apparatus group.

Like the search screen shown in FIG. 5, all of options of keywords are displayed on the same keyword input screen shown in FIG. 8. A plurality of keywords are divided into some fields and grouped. Options of the keywords displayed coincide with those of the search screen (FIG. 5) (the group names of the keyword options in FIG. 8 and those in FIG. 5 are different from each other). By employing such an input screen, entry of keywords to a database, which was conventionally difficult to be achieved, can be surely performed. By performing the operation a plurality of times on the screen, the user naturally grasps the positions of the keywords in the display screen, and time required to find a keyword is largely shortened. As a result, manpower to enter keywords is hardly required. Since the plurality of keywords are divided in some fields and grouped and keywords of different concepts such as the major concept, the middle concept, and the minor concept are displayed in parallel on the same screen, the user can easily enter a plurality of keywords in different categories.

As described above, keywords are entered and necessary information is collected. A report preparing unit 12 (FIG. 1) accepts an input of a keyword selected from the keyword options displayed on the keyword input screen and prepares a report including, as report information, the received keyword, materials prepared by a report preparing person, and report information designated by the report preparing person out of the presented report information. On the other hand, after preparation of the report, without receiving a request from the outside, the report information is stored into the database including the main database 203, company information database 220, and individual information database 230. Since the report information is automatically registered into the database without receiving a request from the outside after preparation of the report, preparation of the report and registration of the report are simultaneously performed. Consequently, if the report is not registered, the report cannot be prepared, so that registration to the database is executed with reliability.

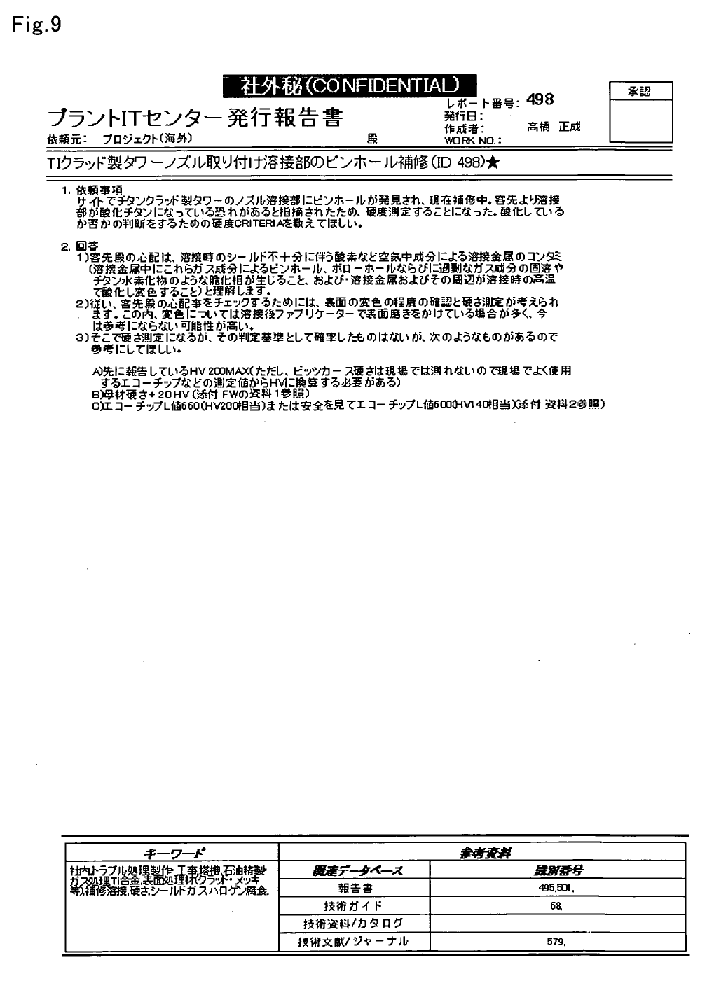

FIG. 9 shows an example of a report prepared. In the report shown in the diagram, in addition to the bibliographical items and report sentences, keywords and reference materials are described. In the reference materials, the kind and the identification number of each of databases stored are described, so that the user can access the database to easily obtain information.

As described above, by sequentially entering the necessary items (hereinbelow, called “report preparation information”) shown in FIG. 6, a report arranged in a predetermined form as shown in FIG. 9 is automatically prepared.

At the stage the entry of the report preparation information completes, the person in charge marks the check box of “process end check” in the form shown in FIG. 4. By the marking, registration of the report to the database completes. After completion of the registration, without receiving a request from the outside, a message indicative of completion of entry of the report preparation to the database is automatically transmitted from the report preparing unit 12 to the authorizer's terminal 6 (authorizer access unit). At this time, the box of “process state” in the inquiry list shown in FIG. 3 is marked. The authorizer recognizes it, opens a screen of the report from the authorizer's terminal, and checks the contents. As a result, if addition, correction, or the like on the contents is necessary, the authorizer leaves the check box of the “process end check” blank and asks the person in charge to re-examine it. In the embodiment, the terminals A, B, C, . . . and the authorizer's terminal in FIG. 1 are connected via the network, and a request for re-examination to the person in charge is transmitted via the network. Concretely, the request for re-examination is made by an e-mail or the like. On the other hand, if there is no addition/correction in the contents of the report, a message indicative of authorization is transmitted from the authorizer's terminal 6 to an authorizing unit 14 (FIG. 1). On receipt of the message transmitted, the authorizing unit 14 accesses the database to obtain necessary report preparation information, based on the information, prepares a report, and transmits the report to the client via a report outputting unit 15. In the authorizing unit 14, the signature of the authorizer may be inserted in the report, and the report with the signature may be transmitted to the client.

Since the procedure of preparation of the report, entry to the database, authorization, and transmission of the report is performed in a series of flow, even if a report is prepared without entering the information to the database, authorization of the authorizer cannot be obtained, and the report cannot be sent. Since entry to the database and preparation of a report are performed simultaneously, the manpower of entry is largely reduced. Further, the related materials can be attached as links, so that the report document itself can be formed simply and, from this viewpoint as well, the manpower of entry to the database is reduced. Moreover, reports are prepared by the method of describing predetermined information in the system. Consequently, the manpower required for preparing a report is largely reduced, and even a person who is not accustomed to the procedure of a work in the section like a new-employed worker or a person who moved in can easily prepare a report of the level similar to that of a veteran worker.

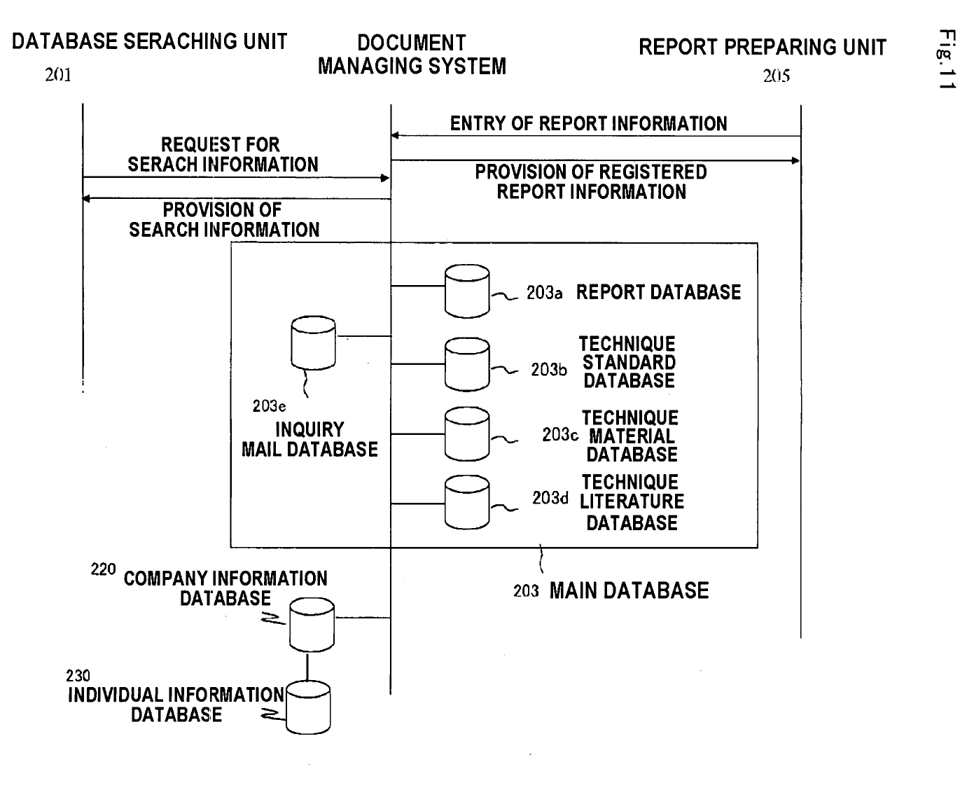

Next, the structure of a database used for report preparation in the embodiment will be described. The details of the configuration of the database in FIG. 1 is as shown in FIG. 11.

The main database 203 is constructed by the following databases.

(a) Report Database (203a)

Information such as trouble report, consulting report, business trip report, and proceeding is stored.

(b) Technique Standard Database (203b)

Materials for an inquiry frequently received, know-how, and the like are stored.

(c) Technique Material Database (203c)

Information such as technical materials of other companies, company catalog, and materials distributed at meetings is stored.

(d) Technique Document Database (203d)

Information such as scientific paper and academic paper is stored.

(e) Inquiry Mail Database (203e)

Inquiry mails from clients are stored as they are.

The system according to the embodiment has, except for the main database 203, the company information database 220 and the individual information database 230. The company information database 220 is a database for storing information such as the address and contact of a company, the name of the person in charge, and the like. The individual information database 230 is a database for storing individual information of information of a name card (name and contact), the relation with a person in charge, and the like.

The graphical user interface and program according to the invention function, in FIG. 11, when a database searching unit 201 sends a request for search information to a document management system and when report information is entered from a report preparing unit 205 to the document management system.

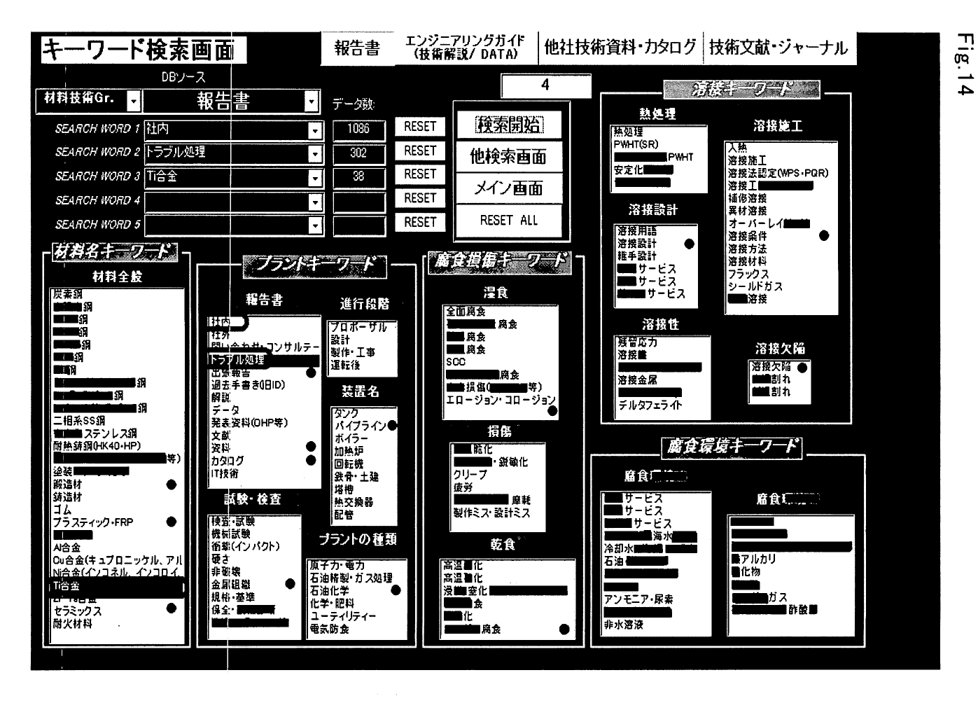

The search screen (FIG. 5) in the embodiment can also have a configuration that predetermined number of keywords are extracted in the decreasing order of use frequency from keywords used in the past for searching operation by the searcher, and the extracted keywords are displayed so as to be emphasized. FIG. 14 shows an example of the configuration. Since the ranges of keywords frequency used by the same searcher are almost fixed, with the configuration, the manpower of search is conspicuously reduced. Although the keywords of high use frequency are circled here, methods of giving background color to a corresponding keyword, displaying the characters of a keyword in a color different from the other characters, displaying characters of a keyword in reverse video, giving a mark to the side of a keyword, making the characters of a keyword blink, and the like can be also employed. A method of providing a check box on the side of a keyword so that the user can mark the check box of a keyword frequently used or the use frequency rank is displayed in the check box can be also employed. In FIG. 14, attention is paid to a searcher and keywords of high use frequency are displayed with emphasis. Alternately, a method of providing a box for selecting a data registrant and displaying a keyword of high use frequency with emphasis by paying attention to the data registrant can be also employed.

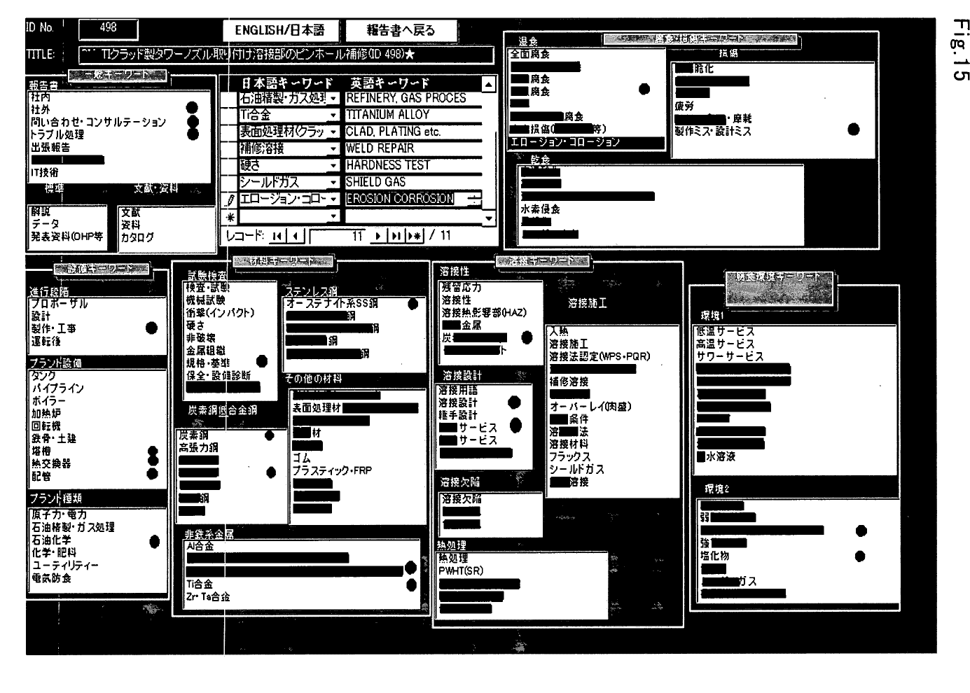

The data registration screen (FIG. 8) in the embodiment can also have a configuration in which predetermined number of keywords are extracted in decreasing order of high use frequency from keywords used in the past by the registrant at the time of registration, and the extracted keywords are displayed with emphasis. FIG. 15 shows an example of the configuration. Since the ranges of keywords frequency used by the same registrant are almost fixed, with the configuration, the manpower of registration is conspicuously reduced. Various methods of display with emphasis can be employed in a manner similar to the above.

In the data registration screen, display for making essential input boxes distinctive such as highlight display can be also employed. In the example of the embodiment, the kind of a report is an item which should be entered, so that the box can be displayed in a color different from the other boxes.

### Second Embodiment

The present invention is directed to improve the efficiency and the like of a keyword search and a keyword registration by displaying all of options of keywords which can be entered on the same screen. A keyword group displayed on the same screen is displayed in correspondence with a mode in which a search or registration is actually going to be executed. A second embodiment employs a configuration in which two kinds of search modes of a general search and a keyword search can be selected. In the case where the general search mode is designated, a keyword group corresponding to the mode is displayed on a single screen. In the case where the keyword search mode is designated, another keyword group corresponding to the mode is displayed on the single screen. The embodiment will be described in detail hereinbelow. In the first embodiment, as shown in FIG. 5, a keyword of a technical term displayed on a single screen is presented as an option, and a search is performed by using the keyword. As keywords, a plurality of terms can be selected and an AND search using them can be also made. In contrast, the second embodiment employs a method of performing a search using not only keywords of technical terms but also bibliographical information of a report, that is, the report issuing section, the author of the report, date and time of preparation of the report, and the like. At the time of collection of materials for preparing a report, by including reports of a section to which the person who prepared the report belongs and sections close to the section in a search range, there is a case that a more efficient search can be performed. A searching method of the second embodiment is constructed for such a purpose.

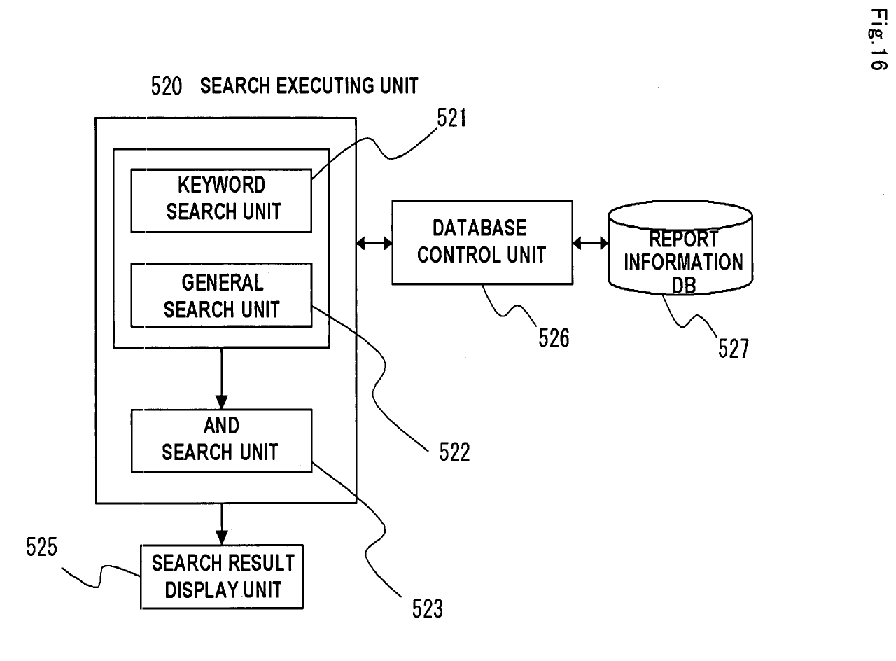

FIG. 16 is a schematic configuration diagram of a search supporting apparatus according to the second embodiment. The apparatus is constructed by, in correspondence with the database searching unit 11 (FIG. 1) in the first embodiment, a search executing unit 520, a search result display unit 525, a database control unit 526, and a report information DB 527. The search executing unit 520 is constructed by a keyword search unit 521, a general search unit 522, and an AND search unit 523. In the report information DB 527, various information constructing a report, that is, report information is stored. The search executing unit 520 retrieves and extracts necessary information from the search executing unit 520 via the database control unit 526. A search includes the keyword search unit 521 for performing a search for a technical term and the general search unit 522 for performing a search on bibliographical information of a report. The result of searches can be used independently of each other and, alternately, processed by the AND search unit 523 to further narrow down the information. The search results obtained in such a manner are presented to the user via the search result display unit 525.

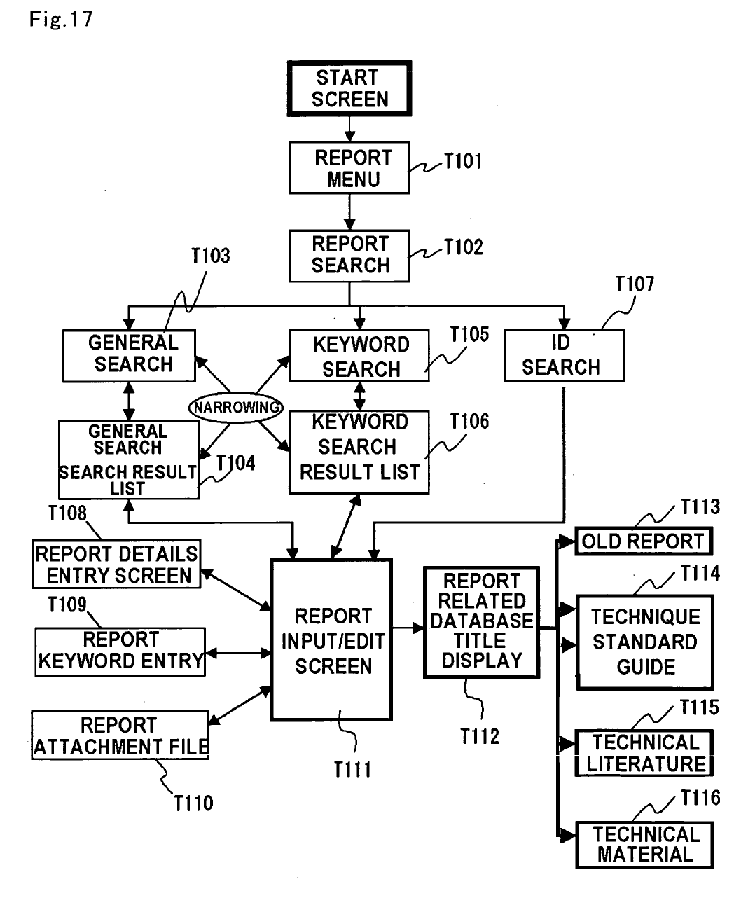

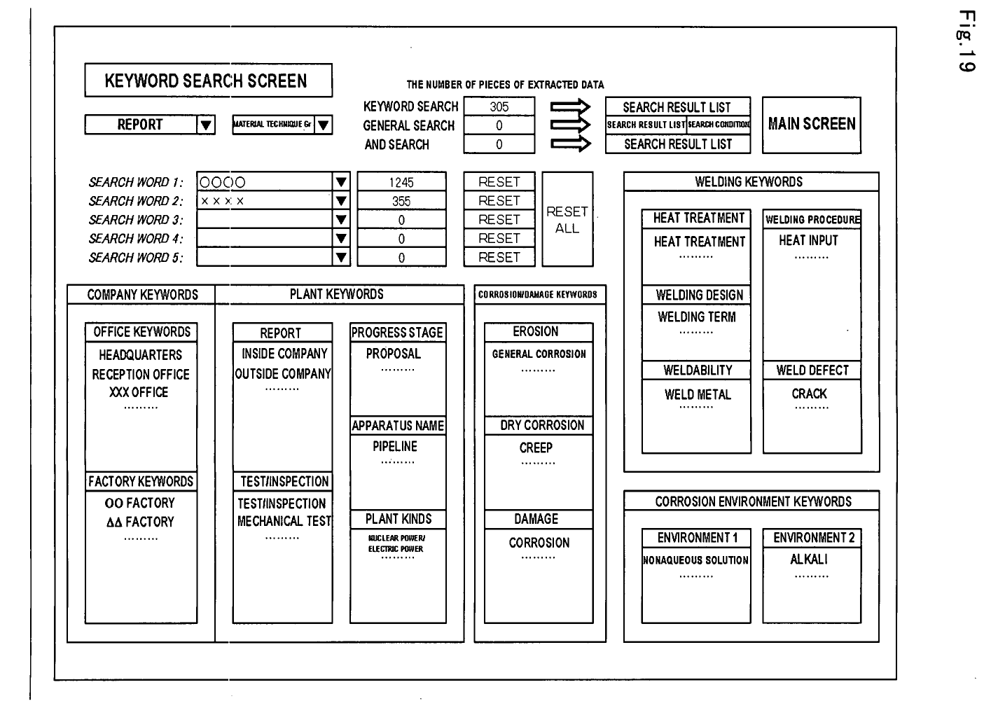

FIG. 17 is a screen flow of a report preparation work managing function realized by the search supporting apparatus shown in FIG. 16. First, a start screen is displayed and, after that, a report menu screen is displayed (T101). Subsequently, the screen of a report search is displayed (T102). FIG. 19 shows an example of the report search screen (keywords are not shown in the diagram), and a general search, a keyword search, and an ID search can be executed from the screen. The keyword search (T105) is executed by entering a predetermined keyword in a keyword input box (search word box) positioned in the left part of the screen of FIG. 19. In the embodiment, by clicking the display of the keyword shown on the search screen, the keyword is displayed in a keyword selection window in the left upper part of FIG. 19, and the inputting operation completes. Such an entry method is efficient because it is easy to select a keyword, upon entry, the selected keyword is displayed in the keyword selection window, and the number of hits is displayed on the side of the keyword selection window. The invention is not limited to the entry method but can employ various methods. A method of writing a keyword in the keyword selection window, a method of giving a radio button on the side of the keyword display box and clicking the button to enter a keyword, and the like can be also employed. In this case, the maximum five keywords can be entered. Options of keywords are selected from the range shown in the screen. The options of the keywords are classified in large items such as material name keyword, plant keyword, and the like. Each of the large items is divided in small items. The number of report documents hit with the keyword is displayed in the center of the screen. In the example, 1245 report documents are hit with the first keyword, and 355 report documents are hit with the second keyword.

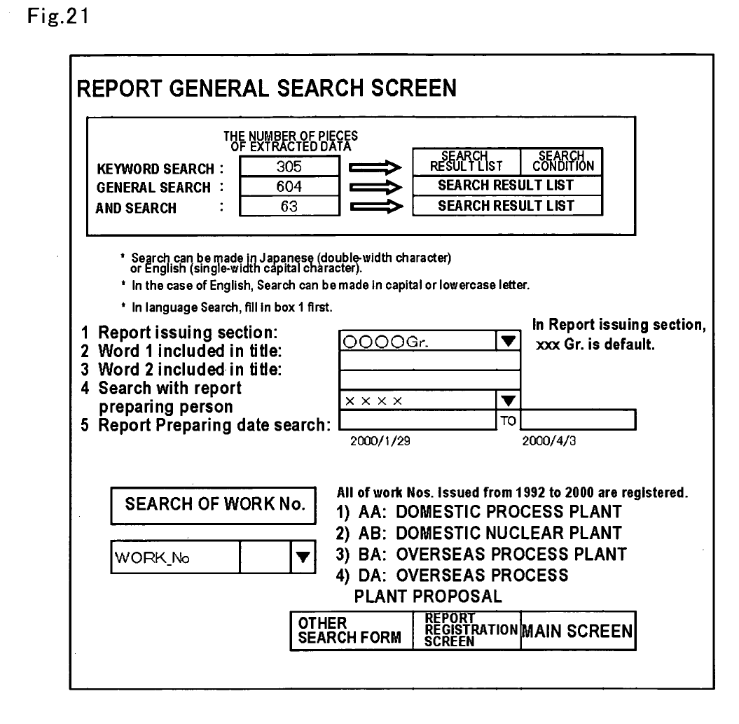

The general search (T103) is made on the screen of FIG. 21 displayed by clicking “search condition” in the line of the general search in the screen of FIG. 19. In the example, as items of the general search, a report issuing section, words included in the title, report preparing person, and report preparation date are written. By entering a keyword in any of the items, the general search is executed. The search results can be displayed by clicking the button of “search result list” corresponding to the general search of FIG. 21 (T104).

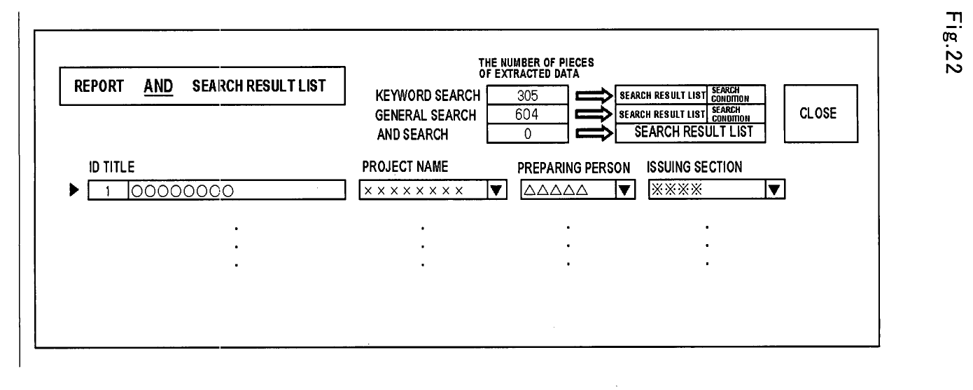

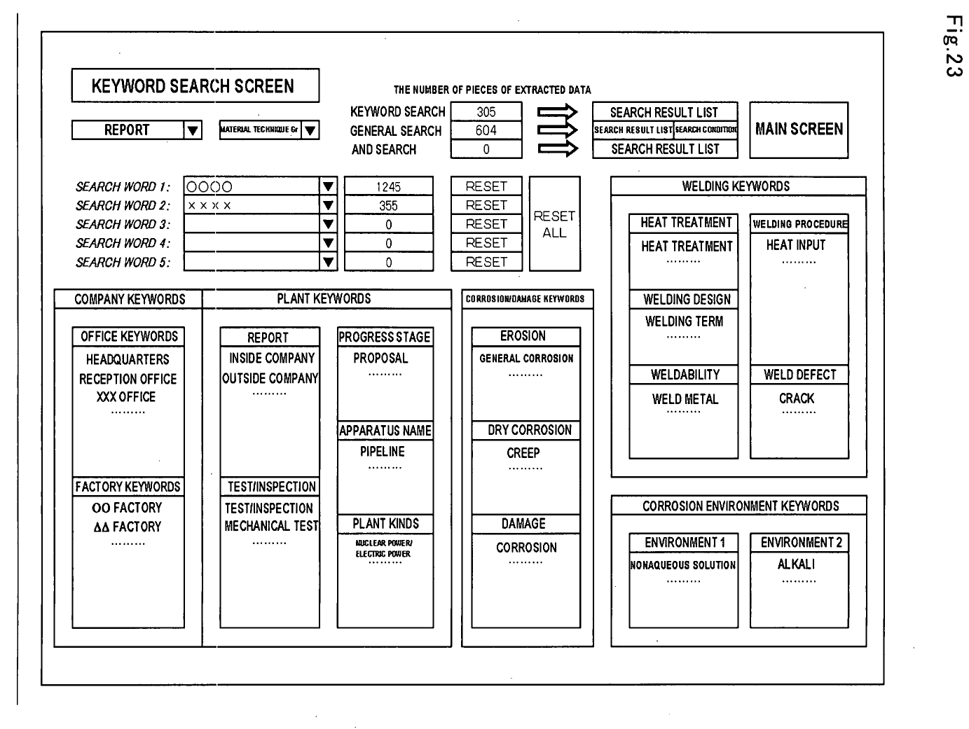

FIG. 23 shows an example of the search screen after the AND search is executed. By clicking the “search result list” button corresponding to the AND search in FIG. 23, a list of 63 results of the AND search shown in FIG. 22 is displayed.

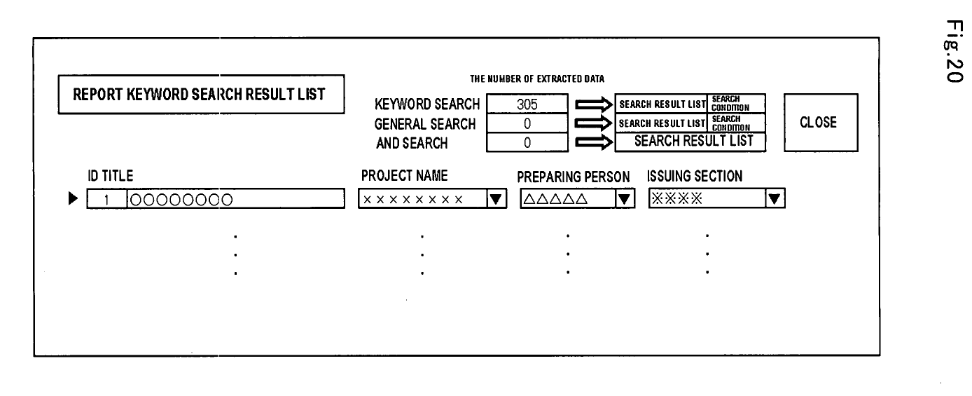

Referring again to FIG. 19, by clicking the button of “search result list” corresponding to the keyword search, the keyword search result list as shown in FIG. 20 is displayed.

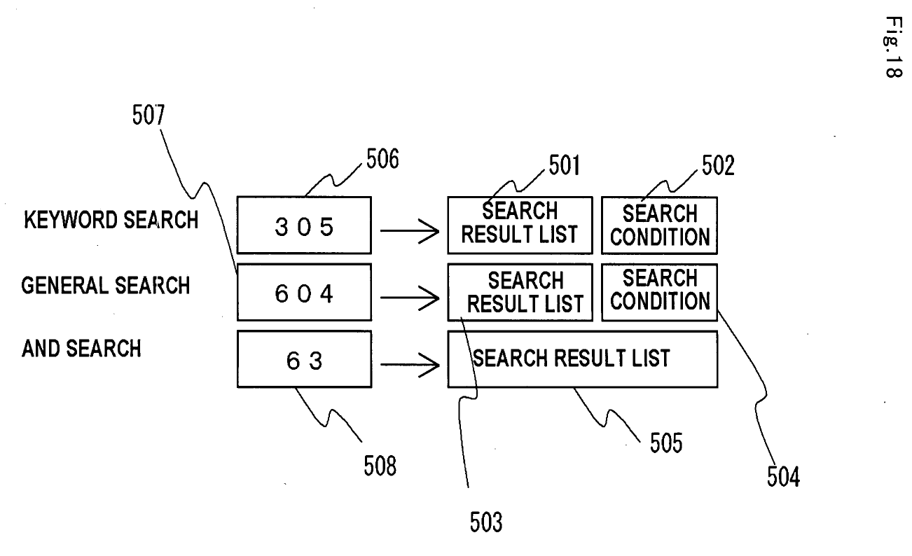

A jump can be made from any of the screens of FIGS. 19 to 23 to a search screen displayed from another search screen or the search result list screen. Consequently, an efficient search can be made. This point will be described with reference to FIG. 18. FIG. 18 shows search execution buttons and search result display boxes in FIG. 20 and the like. In FIG. 18, the number of hits in the keyword search is 305, the number of hits in the general search is 604, and the number of hits in the AND search is 63. In the case where the numerical value of 63 is too large, further narrowing is necessary.

In the example, in the case where the numerical value displayed in a keyword search result box 506 or a general search result box 507 is too large, a search condition button 502 is clicked to re-execute a search, and the result can be confirmed by clicking a search result list button 501. At this time, the numerical value of the keyword search result box 506 changes and, interlockingly, the numerical value displayed in an AND search result box 508 changes. Similarly, a search condition button 504 is clicked to re-execute a search and the result can be confirmed by clicking a search result list button 503. At this time, the numerical value of the general search result box 507 changes and, interlockingly, the numerical value displayed in the AND search result box 508 changes. According to the embodiment, a desired search result can be obtained promptly by a simple operation as described above.

By clicking a search result list button 505 corresponding to the AND search to see the narrowed results, the user can see a list as shown in FIG. 22.

By the procedure described above, the operation of narrowing the report documents from T103 to T106 in FIG. 17 is performed.

In FIG. 17, an ID search (T107) is a method of directly entering report ID number to retrieve a target document. By the search, a document whose ID number is known in advance can be obtained promptly. Since a peculiar ID number is automatically given to a document prepared and stored by the system, such a search is made effectively. Alternately, two kinds of ID numbers, an ID number commonly used in the company and an ID number peculiar to the section may be also used. At the time of registering a report, the ID peculiar to the section is given together with the ID commonly used in the company. Such a method can be realized by determining the section to which the user belongs from the log-in name of the user and storing report information entered by the user so as to be associated with the section.

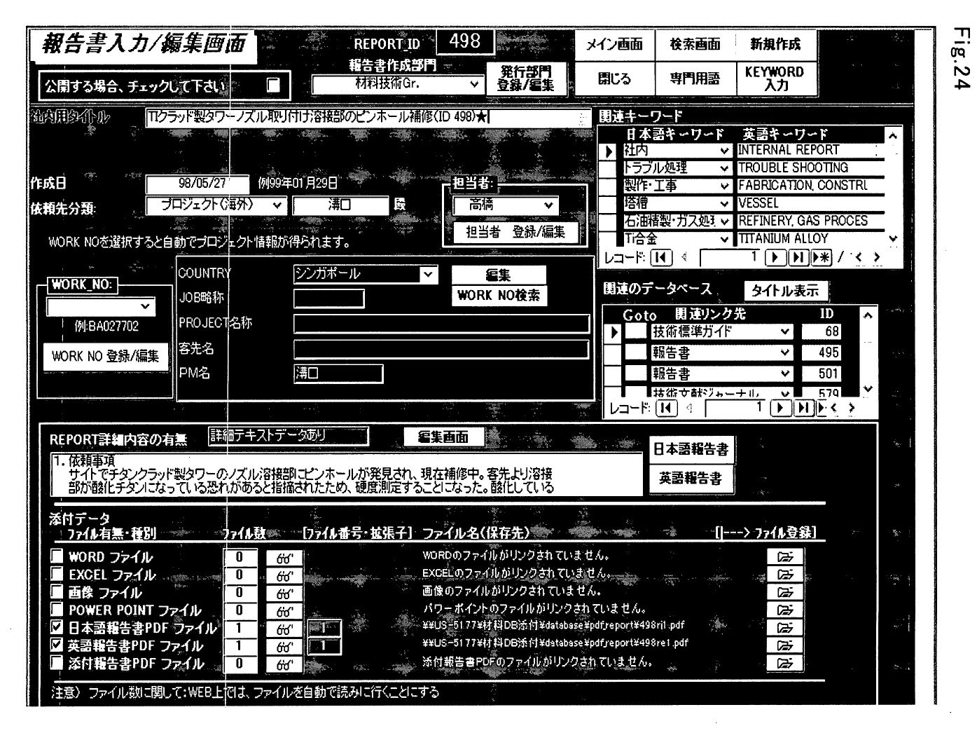

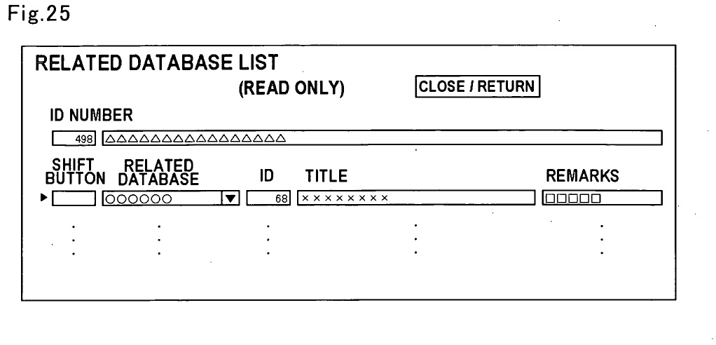

On the basis of a report sentence obtained by the search, a reporter prepares a report. To prepare a report, the screen is moved to “report entry/edit screen” (T111). FIG. 24 shows an example of the report entry/edit screen. From the screen, the program can shift to a report details input screen (T108), a report keyword entry screen (T109), and a report attached file screen (T110). From the report entry/edit screen (T111), the program can shift to, via a report related database title display (T112), each of screens of past report screen (T113), technique standard guide (T114), technique document (T115), and technique materials (T116). The title display in the database corresponds to the button of “title display” positioned in the right middle part of FIG. 24. By clicking the button, a related database list shown in FIG. 25 is displayed. By putting the cursor on a desired database in the list, the details of the desired database can be checked on the screen.

At the time of preparing a report, it is important to attach various kinds of data related to the matter. In the embodiment, data is attached conveniently. The button indicated as “file registration” is placed in the right lower part of FIG. 24. By clicking the button, a desired file can be attached to the report by a single operation. In the conventional methods, the user has to find a folder in which a desired file is stored and grasp the hierarchical structure of the folder. In the embodiment, data can be attached without performing such complicated operations.

### Third Embodiment

Since one of purposes of construction of a knowledge management system using keywords is to share the know-how of people, at the time of introducing the system into a company, introduction of the system to the whole company is the precondition. On the other hand, keywords used at the time of storing data are largely different from each other among sections. Consequently, at the time of keyword search and registration of report documents using keywords, it is efficient to use templates different from each other among sections. A third embodiment relates to a system satisfying the needs. The third embodiment is a modification of linkage among the database searching unit 11, the report preparing unit 12, and the database in the system shown in FIG. 1.

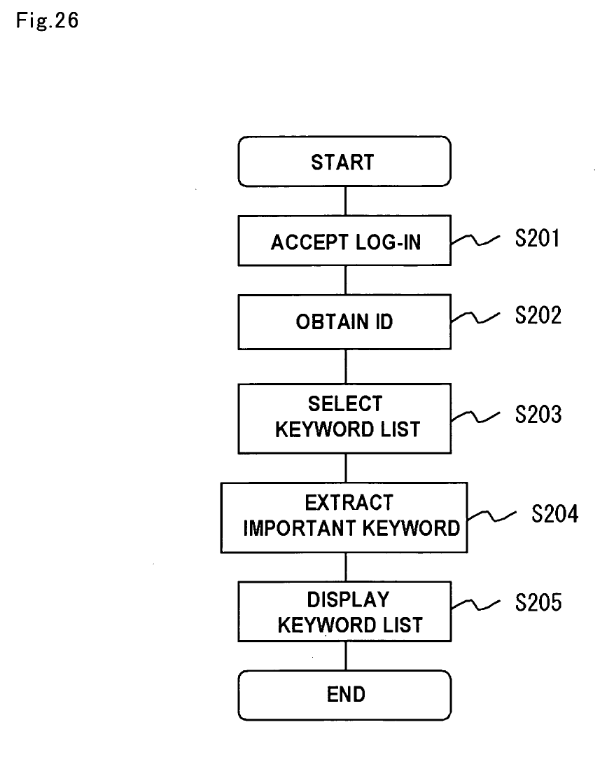

FIG. 26 is a flowchart showing the flow of a search supporting method according to the third embodiment. First, the user logs in the search system. After acceptance of the log-in (S201), the ID is obtained on the basis of the log-in name (S202). Since the section to which the user belongs is found from the ID, a keyword group (keyword list) adapted to the section is selected (S203). After that, data of a search history of the user is obtained from the obtained ID, “important keywords” are extracted (S204), and a keyword list is displayed (S205). The important keywords denote keywords the user frequently uses. By the above, a template of a keyword list according to the section of the user, highlight display of keywords frequently used by the user, and the like are performed, and a keyword search screen is presented.

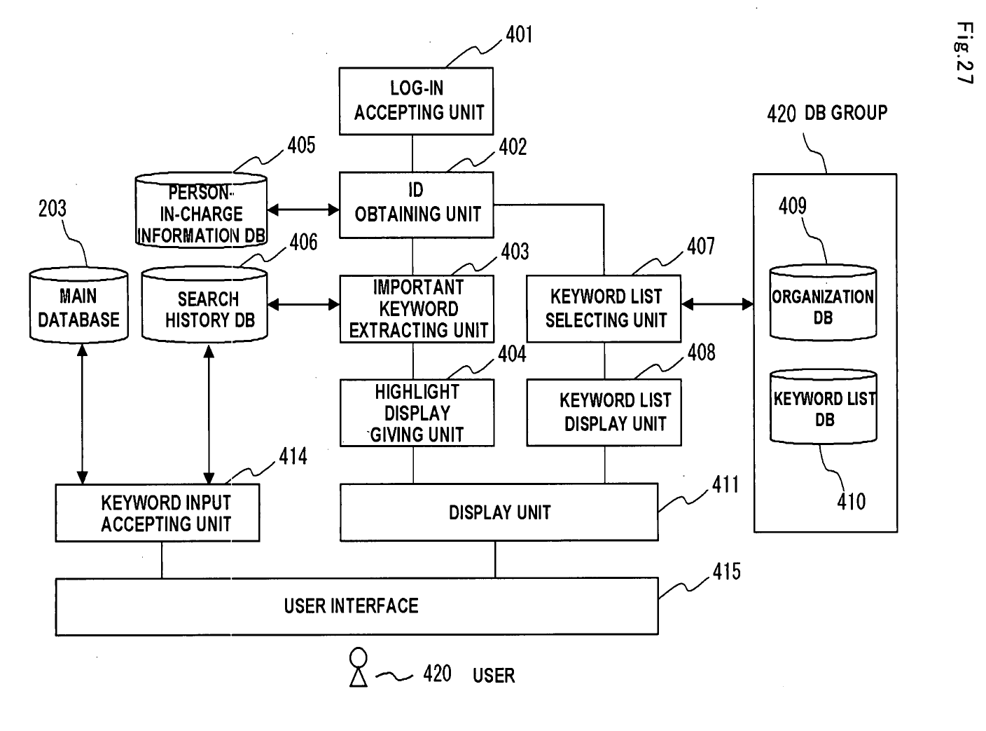

FIG. 27 shows an example of the system configuration realizing the flow of FIG. 26. In the system, out of the search/registration supporting system, function blocks of a part for displaying a keyword list are drawn. In reality, the system has a search executing unit, a registration executing unit, and a database used for search/registration (which are not shown). In the system, by using the log-in name accepted by a log-in accepting unit 401 as a key, an ID is obtained from a person-in-charge information DB 405 by an ID obtaining unit 402. A keyword list selecting unit 407 obtains an organization code of the section to which the user belongs from an organization DB 409 by using the obtained ID as a key, and selects a keyword group corresponding to the organization code from a keyword list DB 410. The selected keyword group is placed on a predetermined template by a keyword list display unit 408.

An important keyword extracting unit 403 extracts important keywords on the basis of information stored in a search history DB 406 by using the obtained ID as a key. As the extracted important keywords, predetermined keywords of the keyword group placed on the predetermined template are highlighted by a highlight display giving unit 404.

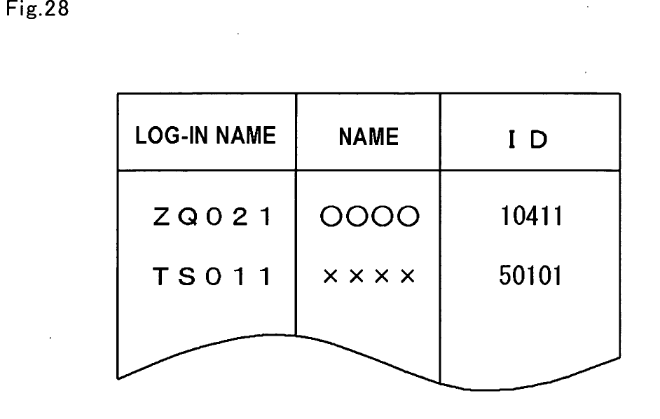

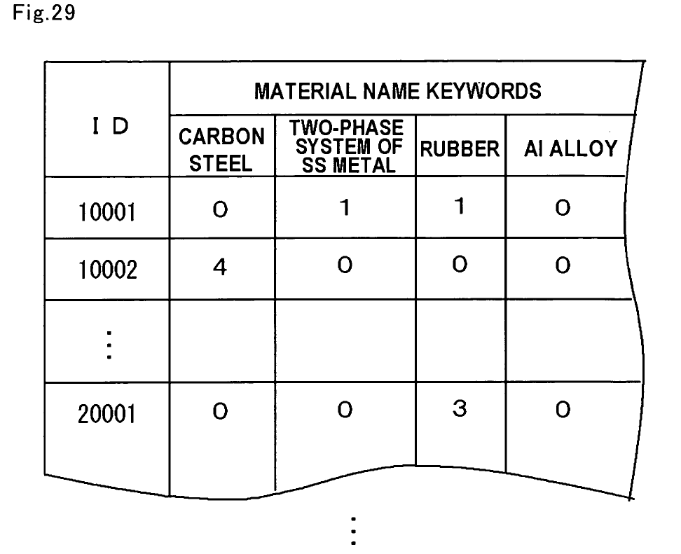

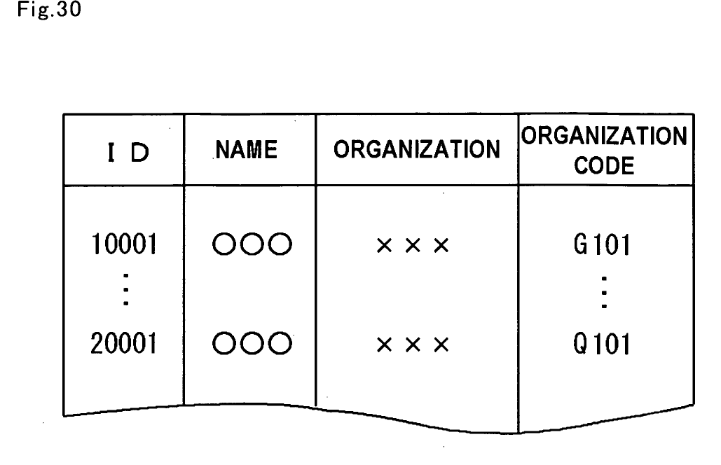

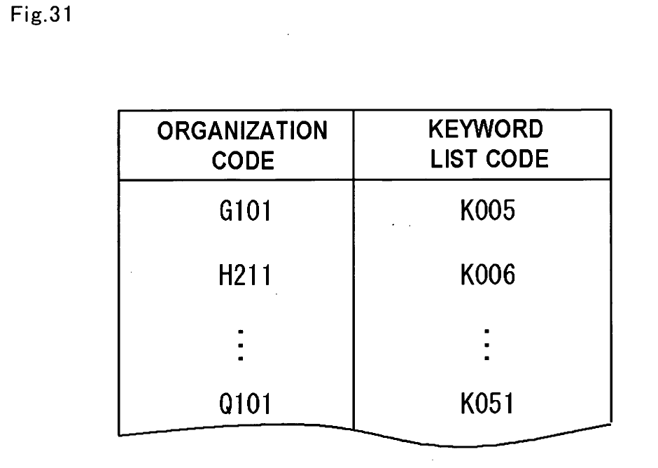

Next, the contents of data stored in the databases shown in FIG. 27 will be described. In the person-in-charge information DB 405, as shown in FIG. 28, a log-in name and a name are stored in association with an ID number. In the search history DB 406, as shown in FIG. 29, a search history is stored in the form of the use frequency of each of keywords. The data is extracted by using an ID number as a key. Data stored in the organization DB 409 is as shown in FIG. 30. Specifically, the name of a person in charge, an organization (a section to which the person in charge belongs), and an organization code are stored so as to be associated with an ID. Further, the data stored in the keyword list DB 410 is stored in correspondence with a keyword list code and an organization code as shown in FIG. 31.

As described above, information obtained by the highlight display giving unit 404 and the keyword list display unit 408 is sent to a display unit 411 in FIG. 27, and a keyword list screen is presented on a user 420. The user 420 watches the keyword list screen and performs a keyword search or a data registration using a keyword. A keyword is entered at the time of search or registration via a user interface 415 and a keyword input accepting unit 414, data associated with the keyword is stored in the main database 203, and a search history is stored in association with the ID of the user in the search history DB.

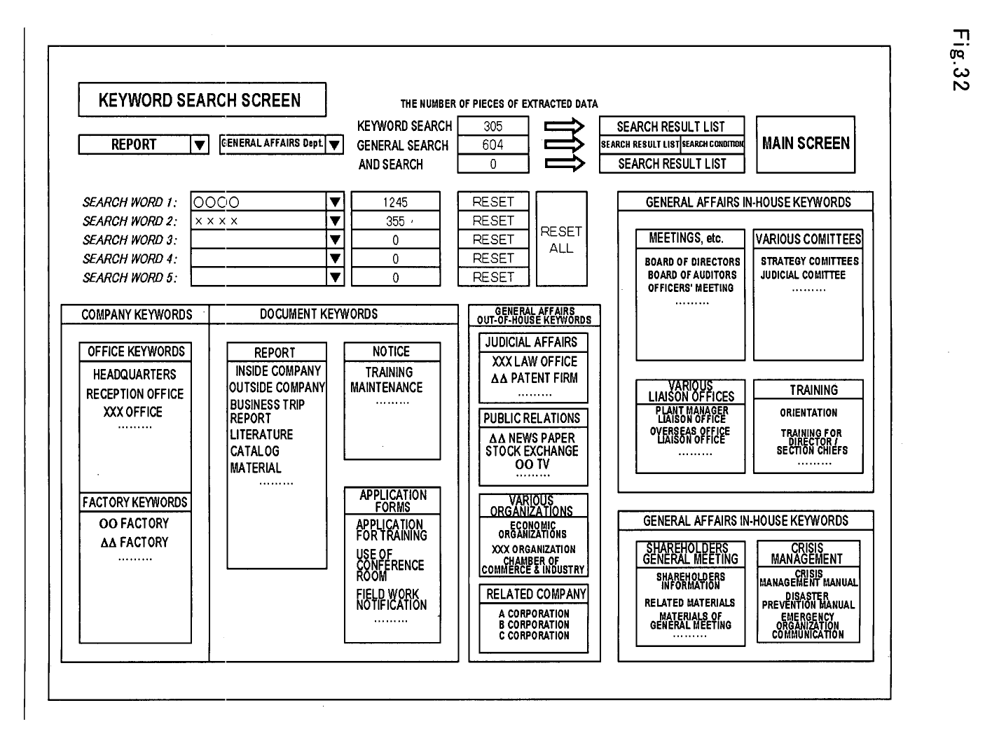

FIGS. 19 and 23 show search screens presented when a user belonging to the material technique Gr. logs in. FIG. 32 shows a search screen presented when a user belonging to the general affairs department logs in. As understood from the diagrams, keywords presented largely vary between the sections. According to the third embodiment, the efficient keyword search/registration can be performed in consideration of the variations among sections.

### Fourth Embodiment

In a fourth embodiment, a modification of linkage among the database searching unit 11, the report preparing unit 12, and the database in the system shown in FIG. 1.

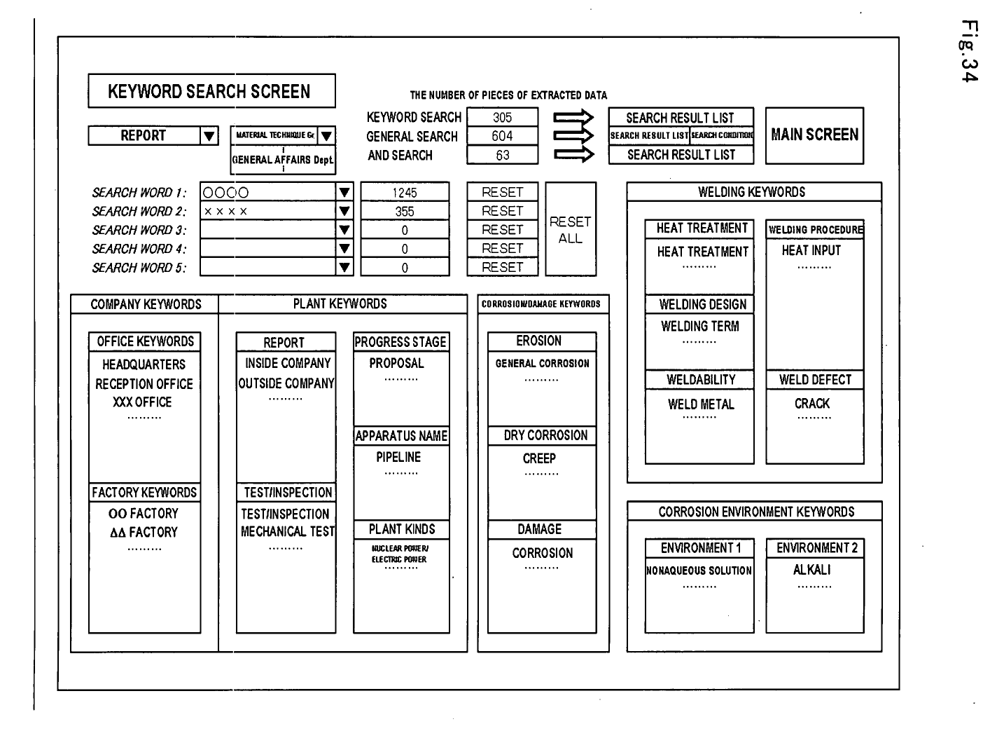

In the third embodiment, from the ID of a user who logged in, a keyword group according to the organization to which the user belongs is presented. In the fourth embodiment, after log-in, a keyword group to be presented can be changed by an operation of the user. For example, after a user belonging to the material technique Gr. logs in, the user can select “general affairs department” in a section entry box positioned in an upper part of the search screen (FIG. 19) (FIG. 34) to switch the search screen to the search screen (FIG. 32) of the general affairs department.

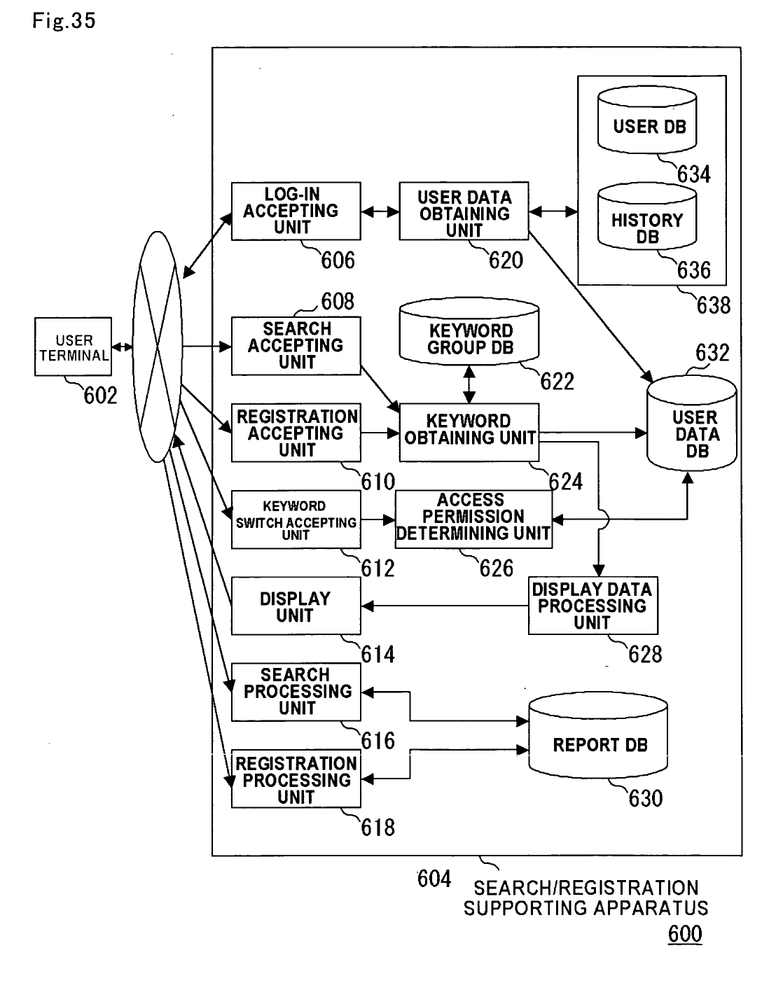

FIG. 35 shows a search/registration supporting system 600 for realizing such an operation. This system is constructed by a user terminal 602 and a search/registration supporting apparatus 604 connected to the user terminal 602 via a network. The system registers report data so as to be associated with a keyword so that a keyword search can be executed on a report already prepared. The search/registration supporting apparatus 604 and the search/registration supporting system 600 have the functions of a report preparation supporting apparatus and a report preparation supporting system, respectively.

In the system, log-in information of the user is accepted by a log-in accepting unit 606, and the log-in name is transmitted to a user data obtaining unit 620. By using the log-in name as a key, the user data obtaining unit 620 obtains data specifying the organization (belonging section) to which the user belongs and the search/registration history of the user with reference to a user DB group 638 constructed by a user DB 634 and a history DB 636 and stores it into a user database 632.

A search accepting unit 608 and a registration accepting unit 610 accept a data search request and a data registration request, respectively, of the user. When the requests are sent to a keyword obtaining unit (keyword selecting unit) 624, the keyword obtaining unit 624 selects a keyword group to be displayed with reference to the user database 632 and a keyword group DB 622. In the user database 632, data having a structure similar to that shown in FIG. 30 is stored. By the data, the user logged in, the organization, and the organization code are associated with each other. On the other hand, in a keyword group DB 622, data having a structure similar to that shown in FIG. 31 is stored. By the data, an organization code and a keyword group to be presented are associated with each other. The keyword obtaining unit 624 obtains an organization code of the user with reference to the user database 632 and, after that, obtains a keyword group corresponding to the organization code from the keyword group DB 622. By the operation, the keyword obtaining unit 624 obtains a search/registration history of the user from the user database 632.

After that, the keyword obtaining unit 624 transmits a keyword group corresponding to the organization code and the search/registration history of the user to a display data processing unit 628. Based on the data, the display data processing unit 628 performs data process such as emphasis display. The processed data is transmitted to a display unit 614 and displays a keyword list on the screen of the user terminal 602.

A keyword switch accepting unit 612 accepts switching of a keyword group from the user. For example, after the user belonging to the material technique Gr. logs in, the user changes “material technique Gr.” to “general affairs department” in the section entry box in the upper part of the search screen of FIG. 19. The keyword switch accepting unit 612 accepts the keyword group switch request and transmits it to an access permission determining unit 626. The access permission determining unit 626 determines whether the user has the authority to view a keyword group of the section by referring to the user database 632. When the access permission determining unit 626 determines that the keyword group can be accessed by the user, the keyword group switch request is transmitted to the keyword obtaining unit 624. The keyword obtaining unit 624 receives the request and obtains the corresponding keyword group from the keyword group DB 622. In the example, the keyword group corresponding to the organization code of the general affairs department is selected by the keyword group DB 622. After the keyword group is selected, the keyword group is transmitted to the display data processing unit 628. The display data processing unit 628 properly performs data process such as emphasis display, transmits the display data to the display unit 614, and displays a keyword list on the screen of the user terminal 602. FIG. 32 shows an example of the screen.

The user selects a predetermined keyword on the screen from displayed keyword groups and performs a search or registration.

A search executing unit 616 accepts a search request from the user and, with the designated keyword, retrieves report data in a report DB 630. A registration executing unit 618 accepts a registration request from the user and stores the designated keyword and the report data to be registered so as to be associated with each other into the report DB 630.

The search processing unit (search executing unit) 616 corresponds to the database searching unit 11 in FIG. 1, and the registration processing unit (registration executing unit) 618 corresponds to the report preparing unit 12 in FIG. 1.

The report DB 630 includes the main database 203, the company information database 220, and the individual information database 230 in FIG. 1, and the main database 203 includes the following.

(a) Report Database (203a)

Information such as trouble report, consulting report, business trip report, and proceeding is stored.

(b) Technique Standard Database (203b)

Materials for an inquiry frequently received, know-how, and the like are stored.

(c) Technique Material Database (203c)

Information such as technical materials of other companies, company catalog, and materials distributed at meetings is stored.

(d) Technique Document Database (203d)

Information such as scientific paper and academic paper is stored.

(e) Inquiry Mail Database (203e)

In the system of the embodiment, a keyword group is displayed according to the organization to which the user belongs. The keyword group is commonly used for a search and a registration. Since such keyword display is performed, a list of keywords frequently used peculiar to the organization is displayed. Such a keyword is a term commonly used in the organization, so that the manpower of a search and a registration is largely reduced, and the work efficiency improves. On the other hand, a keyword group of another section can be properly used, so that sharing of know-how is realized at a level beyond an organization and a section.

Although the keyword list display conspicuously improves the efficiency of a search and a registration, the number of keywords has to be reduced to the degree where a list can be displayed. On the other hand, to make the hit ratio of a keyword search excellent, it is important to assure specialty of a keyword to a certain degree. When options of keywords are general terms only, a number of pieces of data other than target data are hit by a search, and the search efficiency deteriorates. The system simultaneously satisfies such demands. By selecting a keyword group in accordance with the organization to which the user belongs, while maintaining the specialty of a keyword, the number of keywords is reduced to a degree where a list can be displayed. On the other hand, by enabling a search and a registration to be performed with a keyword group other than that of the organization to which the user belongs, data can be stored and utilized at a level beyond an organization and a section.

### Fifth Embodiment

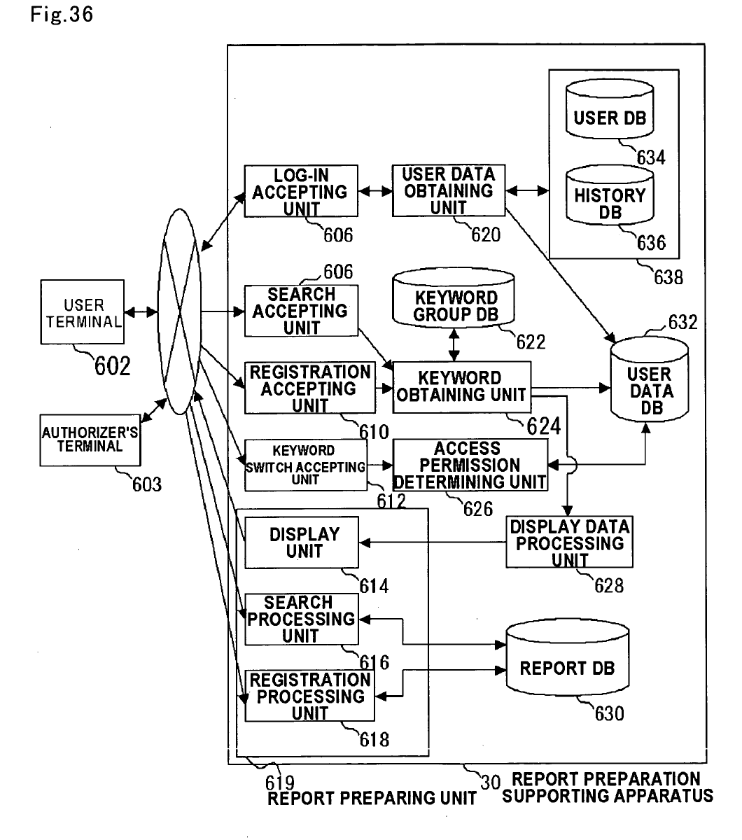

A fifth embodiment is a modification of the report reparation supporting system shown in FIG. 1 and relates to a system having a configuration different from that shown in the fourth embodiment. An apparatus according to the fifth embodiment is shown in FIG. 36. The apparatus supports the preparation of a report by the report preparing person and electronically stores report information constructing the prepared report. The report preparation supporting apparatus is connected to the user terminal 602 and the authorizer's terminal 603 via the network, thereby constructing the report preparation supporting system.

A report preparing unit 619 accesses the report DB 630, presents report information to the user terminal 602, prepares a report in accordance with an instruction of the user, and registers report information constructing the report into the report DB 630. The report preparing unit 619 includes the display unit 614, the search processing unit 616, and the registration processing unit 618.

The display unit 614 displays a keyword search screen, a keyword entry screen, a document hit by a search, a screen for a registering work, and the like.

The search processing unit 616 accepts an entry of a keyword selected from keyword options displayed on the keyword search screen and presents report information of a report corresponding to the keyword to the report preparing person.

The registration processing unit 618 accepts an entry of the keyword selected from keyword options displayed on the keyword input screen and prepares a report including the following as report information.

(i) accepted keyword

(ii) materials prepared by the report preparing person, and

(iii) report information designated by the report preparing person out of the report information presented by the search processing unit 616

After preparation of a report, the report information is stored in the report DB 630 without receiving a request from the outside.

The keyword search screen and the keyword entry screen are screens showing a list of all of options of the keywords. A keyword option displayed on the keyword search screen and that displayed on the keyword entry screen coincide with each other.

After preparation of the report, a report preparing unit 619 notifies the authorizer's terminal 603 and the user terminal 602 of completion of the preparation of the report and the entry of the report information into the database without receiving a request from the outside.

In the apparatus according to the embodiment, the procedure of preparation of the report, entry to the database, and authorization is performed in a flow. If a report is prepared without entry to the database, authorization of the authorizer cannot be obtained. Since the entry of report information to the database and the preparation of a report are performed simultaneously, the manpower for the entry is largely reduced. Further, the related materials can be attached as link forms, so that the report document itself can be formed simply and, from this viewpoint as well, the manpower of entry to the database is reduced. Moreover, reports are prepared by the method of describing predetermined information in the system. Consequently, the manpower required for preparing a report is largely reduced, and even a person who is not accustomed to the procedure of a work in the section like a new-employed worker or a person who moved in can easily prepare a report of the level similar to that of a veteran worker.

### Sixth Embodiment

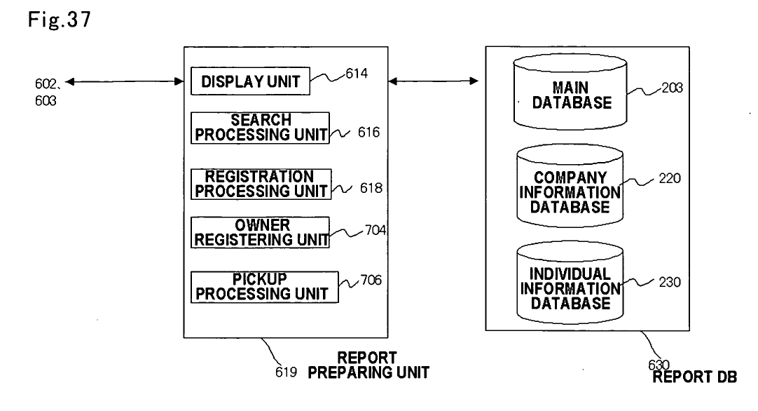

In a sixth embodiment, a modification of the report preparing unit 619 in the fifth embodiment is shown. FIG. 37 shows the configuration of the report preparing unit 619. The report preparing unit 619 in the sixth embodiment is constructed by the display unit 614, the search processing unit 616, an owner registering unit 704, and a pickup processing unit 706.

The report database 630 is constructed by the main database 203, the company information database 220, and the individual information database 230. The main database 203 has a configuration similar to that of the fourth embodiment. The display unit 614 displays a keyword search screen, a keyword entry screen, materials hit by a search, a screen for performing a registering work, and the like. At the time of displaying materials and the like hit by a search, “owner registration button” is simultaneously displayed.

When the user clicks the “owner registration button”, an owner registration request is transmitted to the owner registering unit 704. In response to the request, the owner registering unit 704 gives owner attributes of the user to the displayed materials and stores the resultant as report information into the main database 203.

At the time of displaying the materials and the like hit by a search, the display unit 614 displays a “pickup list”. By performing a predetermined operation on the “pickup list”, the displayed material is registered as report information. Specifically, a related material registration request is transmitted to the pickup processing unit 706, in response to the request, the pickup processing unit 706 gives related material attributes of the user to the displayed resources, and stores the resultant as report information into the main database 203.

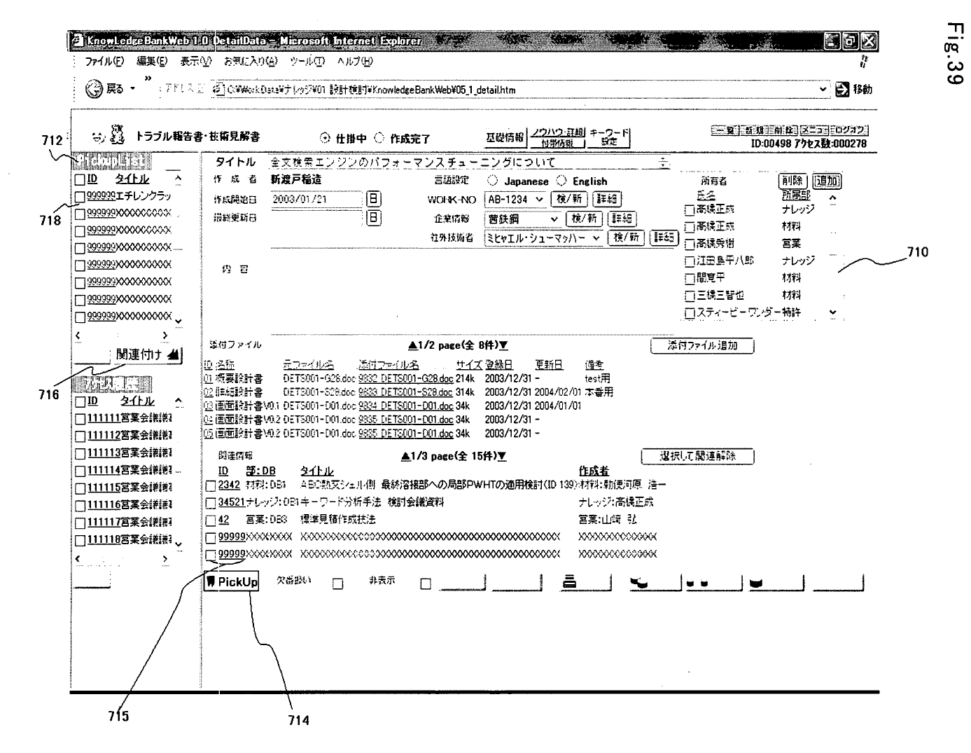

FIG. 39 shows an example of a screen for performing owner registration (addition). The screen has a display screen of a trouble report in a center portion and has an owner registration list display area 710 in an upper right portion. To owner-register a report displayed on the screen, it is sufficient for the user to find his/her name from the owner registration list display area 710 and click it. In such a manner, the displayed report can be attached to the attributes of the owner. By performing the owner registration, a report having the attribute of the name of the owner can be promptly and easily extracted by the owner search.

There is another mode of the owner registration. First, an addition button in the owner registration list display area 710 is clicked. By the click, a new window is open, and a list of people which can be added is displayed. By finding a person the user desires to add to owners (in this case, the user himself/herself) and clicking the name or marking a check box, the person can be added. The window can be constructed in such a manner that all of people who can be added may be displayed or people who can be registered in each of sections may be displayed. For example, a pull-down menu form may be also used in which when a section is selected, a list of people belonging to the section is displayed.

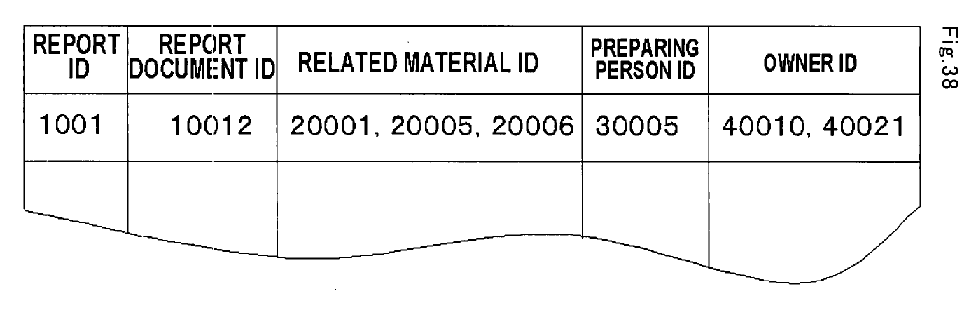

FIG. 38 shows an example of a report record having such an owner attribute. The shown report record has a report ID, a report document ID, a related material ID, a preparing person ID, and an owner ID. The related material ID is the ID of a document registered as a related material of the report. The preparing person ID is the ID of a person who prepared the report. The preparing person ID is given to a report ID in a one-to-one corresponding manner. The owner ID is the ID of a person who performs the owner registration on the report. A plurality of owner IDs can be given to a single report ID.

When an owner addition button in the owner registration list display area 710 in FIG. 39 is clicked, the owner registering unit 704 accesses the main database 203, obtains a record of a trouble report, writes owner attribute data in the field of the owner ID, and stores the resultant to the main database 203.

The procedure of the pickup process in the screen of FIG. 39 will now be described. The pickup process is executed by the following procedure.

(i) Find data associated with report information predicted to be necessary for preparing a report in a keyword search, a general search, or the like.

(ii) Mark a check box 715 given to the data. In the case where there a plurality of check boxes, the plurality of check boxes are marked. Subsequently, a pick up button 714 is clicked.

(iii) The ID or the like of selected data is displayed in a pickup list 712.

(iv) Mark a check box 718 (or check boxes 718) of data actually used at the time of preparing a report or the like in data displayed in the pickup list 712.

(v) When an associating button 716 is clicked, data selected by the pickup list 712 is associated with the ID of a newly prepared report. At this time, the pickup processing unit 706 accesses the main database 203, obtains the record of the trouble report and, after that, writes related material attribute data into the field of the related material ID. The material associated with the report ID is stored in the main database 203.

Since the configuration of the embodiment has the owner registering unit 704, a document frequently used in work can be promptly accessed. In the case where there is no such function, a document has to be found on the basis of the name of the preparing person, the report ID, and the like. By using the owner registering function, data of report information prepared by another person can be retrieved under the user's name, accessibility to necessary information improves, and practical use of information can be further improved. That is, by using the owner registering function, data other than data prepared by the user himself/herself can be also used as if the data is prepared by the user.

Since the pickup processing unit 706 is provided, the manpower to retrieve related materials and register a useful material is largely reduced. Conventionally, when the user finds a useful material in a search of a Web or the like, a method of copying the material, taking a note of the URL of the material, or the like and, later, registering the material as a related material of a target report is employed. In contrast, in the configuration of the embodiment, at the time when a useful material is found, it can be immediately attached as a related document without interrupting a work of searching/registering a related document. Thus, the manpower of preparing a report is further lessened.

According to the embodiment, options of all of keywords are displayed on the same screen. Consequently, by comparing the options, a proper option can be promptly and accurately selected as a keyword. By executing the search a plurality of times, the positions of keywords in the display screen are naturally grasped, and time required to find a keyword is largely shortened. Further, since all of options can be grasped at a glance, at the time of entry of a keyword, the user can enter a plurality of keywords with light burden. As a result, it becomes easier to associate many keywords with data registered in a database, and a useful database can be constructed.

Although the present invention has been described by using the example of applying the invention to an access to a database of the report preparation supporting system, the invention is not limited to the embodiment but can be variously modified.

For example, each of the databases in the foregoing embodiments may be further divided, or some of the databases may be combined.

In the third embodiment, it is also possible to determine the obtained ID from the log-in name and regulate an access as necessary. In such a manner, for example, members who can access secrete data can be regulated in a management department, a human resources department, and the like.

In the third embodiment, in place of the method of selecting a keyword group which is highlight displayed in correspondence with a user at the time of performing highlight-display on the basis of the ID obtained from the log-in name, a method of selecting a keyword group which is highlight displayed in correspondence with the section to which the user belongs can be also employed. In the case where a keyword group which is highlight displayed in correspondence with a user, the key man in the business world can be specified promptly and reliably. In the case where a keyword group which is highlight displayed in correspondence with the section to which the user belongs, the section specializing the matter on which a report is to be prepared can be specified promptly and reliably.

1. A database registration supporting apparatus for supporting the user to register data into a database so as to associate the data with a keyword, comprising:
a display unit for simultaneously displaying all of options of keywords which can be input on a data registration screen and encouraging the user to select any of the keywords;
a keyword input accepting unit for accepting the selected keyword; and
a registration executing unit for registering said data in the database so as to associate the data with the keyword.

2. A database registration supporting apparatus for supporting the user to register data into a database so as to associate the data with a keyword, comprising:
a display unit for presenting a data registration screen and simultaneously displaying all of options of keywords which can be input on the data registration screen;
a keyword input accepting unit, when a displayed option is clicked, which recognizes that the option is selected as a keyword; and
a registration executing unit for registering said data in the database so as to associate the data with the selected keyword.

3. The database registration supporting apparatus according to claim 1, further comprising a user information input unit for encouraging input of user identification information,
wherein said display unit presents the data registration screen by referring to said identification information that is input.

4. The database registration supporting apparatus according to claim 3, further comprising a keyword use history storing unit for storing a keyword use history associated with a user,
wherein said display unit refers to the keyword use history on the basis of said identification information that is input, extracts the predetermined number of keywords in the decreasing order of use frequency from the keywords used for registration by the user in the past, and emphasizes and displays the extracted keywords on the registration screen.

5. The database registration supporting apparatus according to claim 3, further comprising:
a keyword group database for storing a plurality of keyword groups; and
a keyword group selecting unit for selecting a specific keyword group from said keyword group database on the basis of said identification information that is input,
wherein said display unit displays said specific keyword group selected by said keyword group selecting unit as all of options of keywords which can be input.

6. A database search supporting apparatus for supporting the user to retrieve data stored in a database by using a keyword, comprising:
a display unit for simultaneously displaying all of options of keywords which can be input on a data search screen, encouraging the user to select any of the keywords and, when a keyword is selected, displaying a set of the selected keyword and the number of pieces of data including the keyword on the search screen; and
a search executing unit for starting a search with the selected keyword in response to a search start request.

7. A database search supporting apparatus for supporting the user to retrieve data stored in a database by using a keyword, comprising:
a display unit for presenting a data search screen, simultaneously displaying all of options of keywords which can be input on the data registration screen, when a displayed option is clicked, recognizing that the option is selected as a keyword, and displaying a set of the selected keyword and the number of data pieces including the keyword on the search screen; and
a search executing unit for starting a search with the selected keyword in response to a search start request.

8. The database search supporting apparatus according to claim 6, further comprising a user information input unit for encouraging input of user identification information,
wherein said display unit presents the data search screen by referring to said identification information that is input.

9. The database search supporting apparatus according to claim 8, further comprising a keyword use history storing unit for storing a keyword use history associated with a user,
wherein said display unit refers to the keyword use history on the basis of said identification information that is input, extracts the predetermined number of keywords in the decreasing order of use frequency from the keywords used for searches by said user in the past, and emphasizes and displays the extracted keywords on said search screen.

10. The database search supporting apparatus according to claim 8, further comprising a keyword group database for storing a plurality of keyword groups,
wherein said display unit has a keyword group selecting unit for selecting a specific keyword group from said keyword group database on the basis of said identification information that is input, and
said display unit displays said specific keyword group selected by said keyword group selecting unit as all of options of keywords which can be input.

11. The database search supporting apparatus according to claim 6, further comprising a bibliographical information search executing unit for executing a search with bibliographical information of data,
wherein said display unit displays a set of bibliographical information selected at the time of a search and the number of data pieces including the bibliographical information on the search screen, and displays the number of AND search data pieces including both of the selected keyword and the input bibliographical information, and
said number of AND search data pieces changes interlockingly with a change in the bibliographical information and the keyword.

12. A database search/registration supporting apparatus for supporting data search and registration of data on a database, comprising:
a database for storing data;
a keyword storing unit for storing a keyword group used at the time of search of said data and registration of said data so as to be associated with an organization code specifying an organization to which the user belongs;
a user data obtaining unit for obtaining said organization code from the user;
a keyword obtaining unit, when a data search request or a data registration request from the user is accepted, for referring to said organization code obtained and obtaining a keyword group corresponding to said organization code from said keyword storing unit;
a display unit for presenting said keyword group to the user; and
a data processor, when a predetermined keyword is designated from said keyword group displayed, for performing a data search or a data registration by using the keyword.

13. The database search/registration supporting apparatus according to claim 12, wherein said display unit displays said keyword group as all of options of keywords that can be input.

14. The database search/registration supporting apparatus according to claim 12, further comprising a keyword switching unit for switching a keyword group displayed to another keyword group in accordance with a user's request.

15. The database search/registration supporting apparatus according to claim 14, wherein said keyword switching unit includes a determining unit for determining whether the user's request can be addressed or not.

16. A report preparation supporting apparatus for supporting preparation of a report made by a report preparing person and electronically storing report information of a prepared report, comprising:
a database for electronically storing report information; and
a report preparing unit for accessing said database, presenting the report information to said report preparing person, preparing a report in accordance with an instruction of said report preparing person, and registering report information of the report into said database, and
said report preparing unit comprising:
a search processing unit for accepting an input of a keyword selected from keyword options displayed on a keyword search screen, and presenting the report information of a report corresponding to said keyword, stored in said database to the report preparing person; and
a registration processing unit for accepting an input of the keyword selected from the keyword options displayed on a keyword input screen, preparing a report including, as report information, the accepted keyword, materials created by said report preparing person, and report information designated by said report preparing person out of the report information presented by said information presenting unit, and after preparation of the report, storing said report information into said database without receiving a request from the outside.

17. The report preparation supporting apparatus according to claim 16, wherein each of said keyword search screen and said keyword input screen is a screen displaying a list of all of options of keywords.

18. The report preparation supporting apparatus according to claim 16, wherein keyword options displayed on said keyword search screen and keyword options displayed on said keyword input screen match each other.

19. The report preparation supporting apparatus according to claim 16, wherein said report preparing unit obtains a number corresponding to said report preparing person and, after that, presents said keyword search screen and said keyword input screen including keyword options according to an organization to which said report preparing person belongs in consideration of the obtained number.

20. The report preparation supporting apparatus according to claim 16, further comprising an authorizer access unit for presenting predetermined information to an authorizer who authorizes said report,
wherein after preparation of a report, said report preparing unit notifies the authorizer access unit of completion of preparation of said report and input of said report information into the database without receiving a request from the outside.

21. The report preparation supporting apparatus according to claim 16, wherein said search processing unit includes an owner registering unit for giving owner attributes of said report preparing person to said report information presented and storing the resultant report information into said database in accordance with a request from said report creating person.

22. The report preparation supporting apparatus according to claim 16, wherein said search processing unit includes a related material registering unit for giving related material attributes to said report information presented and storing the report information into said database in accordance with a request from said report preparing person, and
said registration processing unit accesses said database, extracts report information to which the related material attributes are given, and creates a report including the extracted report information.

23. A report preparation supporting program for controlling an apparatus for supporting preparation of a report by a report preparing person and electronically storing report information of a prepared report into a database, and making the apparatus execute:
a step of accepting an input of a keyword selected from keyword options displayed on a keyword search screen and presenting report information of a report corresponding to the keyword; and
a step of accepting an input of a keyword selected from keyword options displayed on a keyword input screen, preparing a report including, as report information, the accepted keyword, materials created by said report preparing person, and report information designated by said report preparing person out of said report information presented by said information presenting unit, and after preparation of the report, storing said report information into said database without receiving a request from the outside.

24. The report preparation supporting program according to claim 23, wherein all of options of keywords are displayed on each of said keyword search screen and said keyword input screen.

25. The report preparation supporting program according to claim 23, wherein the same keyword option is displayed on said keyword search screen and said keyword input screen.

26. The database registration supporting apparatus according to claim 2, further comprising a user information input unit for encouraging input of user identification information,
wherein said display unit presents the data registration screen by referring to said identification information that is input.

27. The database registration supporting apparatus according to claim 26, further comprising a keyword use history storing unit for storing a keyword use history associated with a user,
wherein said display unit refers to the keyword use history on the basis of said identification information that is input, extracts the predetermined number of keywords in the decreasing order of use frequency from the keywords used for registration by the user in the past, and emphasizes and displays the extracted keywords on the registration screen.

28. The database registration supporting apparatus according to claim 26, further comprising:
a keyword group database for storing a plurality of keyword groups; and
a keyword group selecting unit for selecting a specific keyword group from said keyword group database on the basis of said identification information that is input,
wherein said display unit displays said specific keyword group selected by said keyword group selecting unit as all of options of keywords which can be input.

29. The database search supporting apparatus according to claim 7, further comprising a user information input unit for encouraging input of user identification information,
wherein said display unit presents the data search screen by referring to said identification information that is input.

30. The database search supporting apparatus according to claim 29, further comprising a keyword use history storing unit for storing a keyword use history associated with a user,
wherein said display unit refers to the keyword use history on the basis of said identification information that is input, extracts the predetermined number of keywords in the decreasing order of use frequency from the keywords used for searches by said user in the past, and emphasizes and displays the extracted keywords on said search screen.

31. The database search supporting apparatus according to claim 29, further comprising a keyword group database for storing a plurality of keyword groups,
wherein said display unit has a keyword group selecting unit for selecting a specific keyword group from said keyword group database on the basis of said identification information that is input, and said display unit displays said specific keyword group selected by said keyword group selecting unit as all of options of keywords which can be input.

32. The database search/registration supporting apparatus according to claim 13, further comprising a keyword switching unit for switching a keyword group displayed to another keyword group in accordance with a user's request.

33. The database search/registration supporting apparatus according to claim 32, wherein said keyword switching unit includes a determining unit for determining whether the user's request can be addressed or not.

34. The report preparation supporting apparatus according to claim 17, wherein keyword options displayed on said keyword search screen and keyword options displayed on said keyword input screen match each other.

35. The report preparation supporting program according to claim 24, wherein the same keyword option is displayed on said keyword search screen and said keyword input screen.
